(19) United States
(12) Patent Application Publication
(10) Pub. No.: US 2024/0318485 A1
(43) Pub. Date: Sep. 26, 2024

(54) REFRIGERATOR

(71) Applicant: LG Electronics Inc., Seoul (KR)

(72) Inventors: Hee Jun LEE, Seoul (KR); Jinho CHANG, Seoul (KR); Jaehoon SHIN, Seoul (KR); Jae Un SHIN, Seoul (KR)

(73) Assignee: LG Electronics Inc., Seoul (KR)

(21) Appl. No.: 18/428,018

(22) Filed: Jan. 31, 2024

(30) Foreign Application Priority Data
Mar. 24, 2023 (KR) 10-2023-0038918

(51) Int. Cl. E05F 5/02; E05D 11/00; F25D 11/00

(52) U.S. Cl. CPC E05F 5/02; E05D 11/0054; F25D 11/00; E05Y 2201/256; E05Y 2201/264; E05Y 2900/31; F25D 2323/024

(57) ABSTRACT

A refrigerator includes a hinge configured to rotatably connect a door to a cabinet, and a damper configured to generate a damping force by contacting the door. The cabinet is coupled to the hinge and supports the hinge, and the hinge is coupled to the damper and supports the damper.

### CROSS-REFERENCE TO RELATED APPLICATION

This application claims priority to and the benefit of Korean Patent Application No. 10-2023-0038918, filed on Mar. 24, 2023, the disclosure of which is incorporated herein by reference in its entirety.

### TECHNICAL FIELD

The present invention relates to a refrigerator, and in particular, a refrigerator provided with a door for opening and closing a storage compartment in which a storage target such as a food item and the like is stored.

### BACKGROUND

Refrigerators produce cold air, based on a circulation of refrigerants, and supply the cold air to a storage compartment, to keep a variety of storage targets fresh in the storage compartment for a long period of time.

A user can open and close a storage compartment formed in a main body of a refrigerator by using a door. As an example, the door may be embodied in different forms such as a rotary door that rotates around one side of the refrigerator, or a drawer door that is inserted and drawn in the front-rear direction.

The refrigerator is provided with a damper providing a damping force to the door. The damper may reduce a noise while absorbing an impact generated during opening and closing of the door.

Specifically, the damper provides a damping force to the door while the door is closed after the door is opened, to close the door smoothly and adjust the closing speed of the door.

For example, the damper may provide a damping force by using a resistant force caused by friction that is generated while a charging material such as oil or gas charging the damper passes through an orifice.

The movement of the charging material in the damper can be performed based on the reciprocation of a piston. The piston can move the charging material in the damper while reciprocating linearly in the cylinder in the damper.

Additionally, the refrigerator may be provided with a pillar. The pillar is provided to prevent the leakage of cold air in the storage compartment, and installed at one side of the door.

For example, a pair of doors is disposed at the refrigerator in the lateral direction, and opens the storage compartment while rotating in a direction where the pair of doors becomes far from each other. For example, a door disposed at the left side of the refrigerator may open and close the left side of the storage compartment, while rotating around the end portion of the left side of the door, and a door disposed at the right side of the refrigerator may open and close the right side of the storage compartment, while rotating around the end portion of the right side of the door.

The pillar may be installed at any one of the pair of doors. Additionally, the pillar may be disposed between the pair of doors as the door is closed.

The pillar may rotate in such a way that the pillar is folded as the door is opened and unfolded as the door is closed. The pillar may be folded not to protrude in the lateral direction of the door as the door is opened, and unfolded to block a gap between the pair of doors as the door is closed.

An example of a damper installed at a refrigerator is disclosed in prior art document 1 (KR Patent Publication No. 10-2016-0102681).

Referring to FIGS. 33 and 34, the refrigerator of prior art document 1 comprises a hinge 80, a hinge cover and a damper.

The hinge 80 is provided to connect a cabinet 1 and a door 31 of the refrigerator and rotatably supports the door 31. The hinge 80 is installed at the cabinet 1. The hinge cover covers the hinge 80 and is coupled to the upper wall of the cabinet 1.

The damper 40 comprises a damper apparatus 50 and a damper housing. In the damper, the damper apparatus 50 provides a damping function substantially. Additionally, the damper housing couples the damper apparatus 50 to the hinge cover.

The damper apparatus 50 comprises a cylinder 51, a piston 60, a press rod 61 and a damping fluid.

The piston 60 moves back and forth in the cylinder 51, and the damping fluid filling the inner space of the cylinder 51 provides a damping force to the piston 60 while being pressed slowly as the piston 60 moves.

The press rod 61 connects to the piston 60 and extends up to the outside of the piston 60. The press rod 61 is a portion that is directly pressed against the door 31 as the door 31 is closed.

As the door 31 is closed, the door 31 presses the press rod 61, to move the press rod 61, and accordingly, the press rod 61 presses the piston 60 while moving toward the inside of the cylinder 51.

The piston 60 presses the damping fluid in the cylinder 51, while being moved by the press rod 61. As described above, the damping fluid pressed by the piston 60 is slowly pressed, and accordingly, the damper apparatus 50 provides a damping force.

The door 31 comprises a thermal insulation material for thermally insulating the storage compartment, and a door guard storing a food item may be provided on the rear surface of the door 31. The door 31 weighs significantly because of food items stored in the door guard and the thermal insulation material.

Due to the weight of the door 31, a significant impact may be applied to the press rod 61 that directly contacts the door 31 as the door 31 is closed.

The door 31 may be provided with a press roller part 36. The press roller part 36 may press the press rod 61 gently as the door 31 is closed, and accordingly, an impact applied to the press rod 61 may decrease as the door 31 is closed.

In the case where the door 31 sags, a force may be applied to the press roller part 36 and the press rod 61 contacting the press roller part 36 in an up-down direction. The force applied may act as a force that causes wear or damage to the press roller part 36 or the press rod 61.

However, the press roller part 36 in prior art document 1 can hardly respond to an effect of the force applied due to the sagging of the door 31 properly.

### SUMMARY

### Technical Problems

The objective of the present invention is to provide a refrigerator having an improved structure in which a damping function is provided smoothly even in the case where a door sags.

Another objective of the present invention is to provide a refrigerator having an improved structure in which a component in relation to a damping function causes no deterioration in the aesthetic qualities of the refrigerator.

Another objective of the present invention is to provide a refrigerator having an improved structure in which a component in relation to a damping function is protected from damage.

Yet another objective of the present invention is to provide a refrigerator having an improved structure in which the durability of a component in relation to a damping function improves.

### Technical Solutions

In one aspect, a refrigerator comprises a hinge configured to rotatably connect a door to a cabinet, and a damper configured to generate a damping force by contacting the door, and the cabinet is coupled to the hinge and supports the hinge, and the hinge is coupled to the damper and supports the damper.

The damper is accommodated in a hinge case covering the upper portion of the hinge, and the hinge may be made of a metallic material having greater strength than a material for the hinge case.

In another aspect, a refrigerator comprises a hinge configured to rotatably connect a door to a cabinet, a damper configured to generate a damping force by contacting the door, and a contact projection provided at the door and configured to protrude toward the damper, and the contact projection comprises a contact surface formed in a rounded manner and configured to contact the damper.

In another aspect, a refrigerator comprises a hinge coupled to the cabinet, a damper coupled to the hinge and supported by the hinge, and a contact projection provided at the door and configured to protrude toward the damper, and the damper generate a damping force by contacting the contact projection, and the contact projection comprises a contact surface formed in a rounded manner and configured to contact the damper.

A refrigerator in one aspect may comprise a cabinet provided with a storage compartment; a door rotatably installed at the cabinet and configured to open and close the storage compartment; a hinge configured to rotatably connect the door to the cabinet; and a damper installed at the hinge and configured to generate a damping force by contacting the door.

Preferably, the cabinet may be coupled to the hinge and support the hinge. The hinge may be coupled to the damper and support the damper.

According to the present invention, the refrigerator may further comprise a hinge case configured to accommodate at least a portion of the hinge and coupled to the hinge.

Preferably, at least a portion of the damper may be accommodated in a space surrounded by the hinge and the hinge case.

Preferably, the hinge may comprise a first hinge main body disposed in an area where the first hinge main body overlaps the cabinet in an up-down direction and coupled to the cabinet, and a second hinge main body configured to protrude to a front of the cabinet and connected to the door.

Preferably, the damper may be coupled to the second hinge main body and accommodated in a space surrounded by the second hinge main body and the hinge case.

Preferably, a hinge mounting space open toward the cabinet may be provided in the door. The hinge may connect to the door, in the hinge mounting space.

Preferably, as the door closes the storage compartment, the second hinge main body and the hinge case is inserted into the hinge mounting space.

A refrigerator in another aspect may comprise a cabinet provided with a storage compartment; a door rotatably installed at the cabinet and configured to open and close the storage compartment; a hinge configured to rotatably connect the door to the cabinet; a damper installed at the hinge; and a contact projection provided at the door and configured to protrude toward the damper.

Preferably, the damper may generate a damping force by contacting the contact projection. The contact projection may comprise a contact surface formed in a rounded manner and configured to contact the damper.

Additionally, the hinge case may comprise an upper surface part configured to cover the hinge from above with the damper between the upper surface part and the hinge; a front surface part configured to connect between the hinge and the upper surface part while blocking between the damper and the contact projection; and an exit hole configured to form a passage for allowing the contact projection to pass through the front surface part and to move toward the damper, at the front surface part.

Preferably, the exit hole may be formed in such a way that the exit hole penetrates the front surface part in a front-rear direction. The contact projection may have a shape in which a length in the up-down direction and in a lateral direction increases toward a rear of the shape.

Further, the damper may comprise a fixation part fixed to the door, and a movement part movably installed at the fixation part.

Preferably, the movement part may have a contact end having a planar shape, at an end portion thereof. The movement part may move in the front-rear direction while the contact end contacts the contact surface.

Preferably, the contact projection may be rounded in the up-down direction and the lateral direction, and formed convexly toward the damper.

Preferably, the contact projection protrudes in a hemisphere shape toward the damper.

Preferably, the contact projection is disposed in the hinge mounting space.

Preferably, the refrigerator may further comprise a door cover at least a portion of which is inserted into the hinge mounting space, and which is installed at the door.

Preferably, the contact projection may be installed at the door cover.

Preferably, the hinge mounting space may form a space that is depressed forward from a rear surface of the door, in the door.

Preferably, the door cover may comprise an upper surface cover part configured to cover an upper surface of an inside of the door in the hinge mounting space, and a front surface cover part configured to connect to the upper surface cover part while covering a front surface of the inside of the door in the hinge mounting space.

Preferably, the contact projection is installed at the front surface cover part and protrudes rearward from the front surface cover part.

Further, the hinge mounting space may be spaced downward from an upper end of the door by a predetermined distance.

Further, a cut part may be formed between the upper end of the door and the hinge mounting space, on a rear surface of the door.

Preferably, the door cover may further comprise a rear surface cover part configured to cover the cut part and to connect to the upper surface cover part.

Further, the door cover may further comprise a projection coupling boss configured to protrude rearward from the front surface cover part.

Preferably, the contact projection may be coupled to the projection coupling boss and protrude rearward from the projection coupling boss.

A refrigerator in another aspect may comprise a cabinet provided with a storage compartment; a door rotatably installed at the cabinet and configured to open and close the storage compartment; a hinge coupled to the cabinet, and configured to rotatably connect the door to the cabinet; a damper coupled to the hinge and supported by the hinge; and a contact projection provided at the door, and configured to protrude toward the damper.

Preferably, the damper may generate a damping force by contacting the contact projection, and the contact projection may comprise a contact surface formed in a rounded manner and configured to contact the damper.

### Advantageous Effects

According to the present invention, an effect of sagging of the door may be offset by a slide of the damper assembly along the curved surface of the contact projection, such that the operation of the damper assembly is performed smoothly as set regardless of whether the door sags or not.

According to the present invention, a damping function may be performed smoothly regardless of whether the door sags or not.

According to the present invention, the refrigerator may be provided with the damper assembly that effectively provides a damping force needed to adjust a rotation speed of the door and that remains hidden at a position that is hardly seen, such that the quality feeling and quality exterior of the refrigerator improve.

According to the present invention, the damper assembly installed between the cabinet and the door does not form a structure protruding from the door or the cabinet and the like, such that the damper assembly is protected effectively from damage caused by a collision with another object.

According to the present invention, as a main component in relation to the damping function, the structural reliability and strength of the contact projection improves, such that the durability of the contact projection improves while wear and damage to the contact projection are suppressed.

### BRIEF DESCRIPTION OF DRAWINGS

The accompanying drawings constitute a part of the specification, illustrate one or more embodiments in the invention, and together with the specification, explain the invention, wherein:

FIG. 1 is a perspective view of a refrigerator of a first embodiment;

FIG. 2 is a plan view of the refrigerator illustrated in FIG. 1;

FIG. 3 is a plan view of the refrigerator illustrated in FIG. 2 with a door open;

FIG. 4 is a rear perspective view of a portion of the refrigerator illustrated in FIG. 1;

FIG. 5 is an enlarged view of a portion of FIG. 4;

FIG. 6 is a planar cross-sectional view of the inner structures of a damper assembly and a hinge assembly illustrated in FIG. 5;

FIG. 7 is a perspective view separately showing a damper assembly illustrated in FIG. 5;

FIG. 8 is an exploded perspective view of an exploded state of the damper assembly illustrated in FIG. 7;

FIG. 9 is a rear view of a damper cover illustrated in FIG. 8;

FIG. 10 is a front view of a damper case illustrated in FIG. 7;

FIG. 11 is a front view of the damper assembly illustrated in FIG. 7;

FIG. 12 is an exploded perspective view of an exploded state of a damper illustrated in FIG. 7;

FIG. 13 is a lateral cross-sectional view of the inner structure of the damper illustrated in FIG. 12;

FIGS. 14 and 15 are lateral cross-sectional views of a compressed state of the damper illustrated in FIG. 13;

FIGS. 16 and 17 are lateral cross-sectional views of a returned state of the damper illustrated in FIG. 15;

FIG. 18 is a front cross-sectional view of a damper for showing an oil inflow path in the damper;

FIG. 19 is a view of an inlet of oil in a state where a ring contacts a first piston part;

FIG. 20 is a rear view of a piston illustrated in FIG. 19;

FIG. 21 is a side view of an outlet of oil in a state where a ring contacts a first piston part;

FIG. 22 is a front view of a piston illustrated in FIG. 21;

FIG. 23 is a lateral cross-sectional view of a damper for showing an oil flow path part in a state where a ring contacts a first piston part;

FIG. 24 is a side view of a returned state of a damper;

FIG. 25 is a lateral cross-sectional view of the damper illustrated in FIG. 24;

FIG. 26 is a planar cross-sectional view of the inner structures of a damper assembly and a hinge assembly of one embodiment;

FIG. 27 is a plan view separately showing the damper assembly and the hinge assembly illustrated in FIG. 26;

FIG. 28 is a perspective view separately showing the damper assembly and the hinge assembly illustrated in FIG. 26;

FIG. 29 is an exploded perspective view of exploded states of the damper assembly and the hinge assembly illustrated in FIG. 28;

FIG. 30 is an exploded perspective view of the damper assembly illustrated in FIG. 28 separating from the hinge assembly illustrated in FIG. 28;

FIG. 31 is a planar cross-sectional view of mounted states of the damper assembly and the hinge assembly of one embodiment;

FIG. 32 is a planar cross-sectional view of an operating state of the damper assembly illustrated in FIG. 31;

FIG. 33 is an exploded perspective view of a main part of a refrigerator of a related art; and

FIG. 34 is a cross-sectional view of an installation structure of a damper of the refrigerator of the related art.

### DETAILED DESCRIPTION

The above-described aspects, features and advantages are specifically described hereafter with reference to accompanying drawings such that one having ordinary skill in the art to which the invention pertains can embody the technical scope of the invention easily. In the invention, detailed description of known technologies in relation to the subject matter of the invention is omitted if it is deemed to make the gist of the invention unnecessarily vague Hereafter, preferred embodiments according to the invention are specifically described with reference to the accompanying drawings. In the drawings, identical reference numerals can denote identical or similar components.

The terms “first,” “second” and the like are used herein only to distinguish one component from another component. Thus, the components are not to be limited by the terms. Certainly, a first component can be a second component, unless stated to the contrary.

Embodiments are not limited to the embodiments set forth herein, and can be modified and changed in various different forms. The embodiments in the invention are provided such that the invention can be through and complete and fully convey its scope to one having ordinary skill in the art. Accordingly, all modifications, or replacements as well as a replacement of the configuration of any one embodiment with the configuration of another embodiment or an addition of the configuration of any one embodiment to the configuration of another embodiment, within the technical scope of the invention, are to be included in the scope of the invention.

The accompanying drawings are provided for a better understanding of the embodiments set forth herein and are not intended to limit the technical scope of the invention. It is to be understood that all the modifications, or replacements within the technical scope of the invention are included in the scope of the invention. The sizes or thicknesses of the components in the drawings are exaggerated or reduced to ensure ease of understanding and the like. However, the protection scope of the subject matter of the invention is not to be interpreted in a limited way.

The terms in the invention are used only to describe specific embodiments or examples and not intended to limit the subject matter of the invention. In the invention, singular forms include plural forms as well, unless explicitly indicated otherwise. In the invention, the terms “comprise,” “comprised of” and the like specify the presence of stated features, integers, steps, operations, elements, components or combinations thereof but do not imply the exclusion of the presence or addition of one or more other features, integers, steps, operations, elements, components or combinations thereof.

The terms “first,” “second” and the like are used herein only to distinguish one component from another component, and the components are not to be limited by the terms.

When any one component is described as “connected” or “coupled” to another component, any one component can be directly connected or coupled to another component, but an additional component can be “interposed” between the two components or the two components can be “connected” or “coupled” by an additional component. When any one component is described as “directly connected” or “directly coupled” to another component, an additional component cannot be “interposed” between the two components or the two components cannot be “connected” or “coupled” by an additional component.

When any one component is described as being “on (or under)” another component, any one component can be directly on (or under) another component, and an additional component can be interposed between the two components.

Unless otherwise defined, all the terms including technical or scientific terms used herein have the same meaning as commonly understood by one having ordinary skill in the art. Additionally, terms such as those defined in commonly used dictionaries are to be interpreted as having a meaning that is consistent with their meaning in the context of the relevant art, and unless explicitly defined herein, are not to be interpreted in an ideal way or an overly formal way.

In the state where a refrigerator stands on the floor, a direction in which a door is installed with respect to the center of the refrigerator is defined as a forward direction. Accordingly, a direction toward the inside of the refrigerator with the door open is defined as a rearward direction. For convenience, the forward direction and the rearward direction can be referred to as a first direction. Then the forward direction is referred to as one direction of the first direction, and the rearward direction is referred to as the other direction of the first direction.

Additionally, a gravitational direction can be defined as a downward direction, and a direction opposite to the gravitational direction can be defined as an upward direction.

Further, a horizontal direction across a front-rear direction of the refrigerator, i.e., a widthwise direction of the refrigerator that is seen in front of the door of the refrigerator, can be referred to as a left-right direction. For convenience, the left-right direction can be referred to as a second direction. Then the right side can be referred to as one direction of the second direction, and the left side can be referred to as the other direction of the second direction.

Further, the widthwise direction of the refrigerator can also be referred to as a lateral direction. Then the right side can also be referred to as one side of the lateral direction, and the left side can be referred to the other side of the lateral direction.

Additionally, an up-down direction can be referred to as a third direction. Then an upward direction can be referred to as one direction of the third direction, and a downward direction can be referred to as the other direction of the third direction.

Furthermore, the up-down direction can be referred to as a vertical direction. Then the front-rear direction and the left-right direction, i.e., the first direction and the second direction, can be referred to as the horizontal direction.

Throughout the invention, the terms “A and/or B” as used herein can denote A, B or A and B, and the terms “C to D” can denote C or greater and D or less, unless stated to the contrary.

### [Entire Structure of Refrigerator]

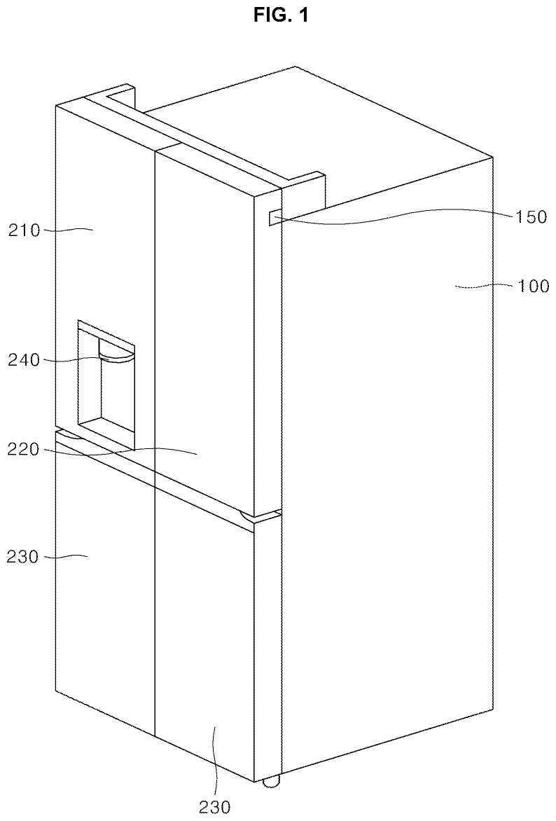

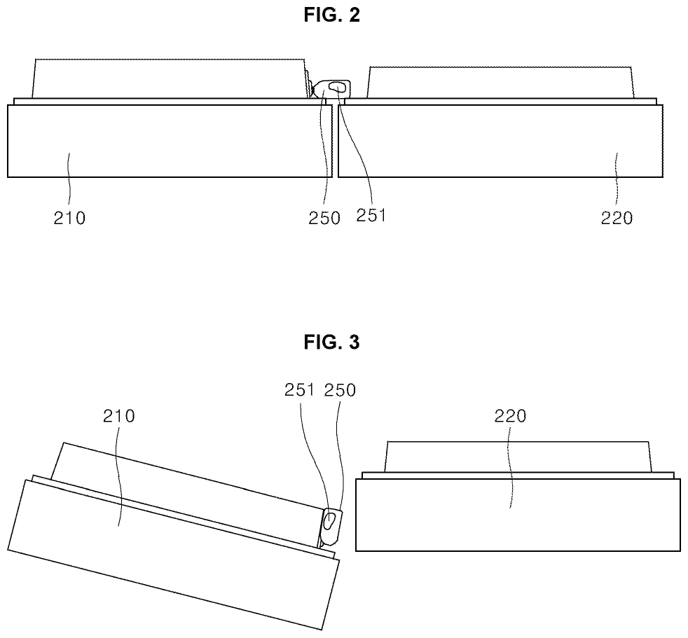

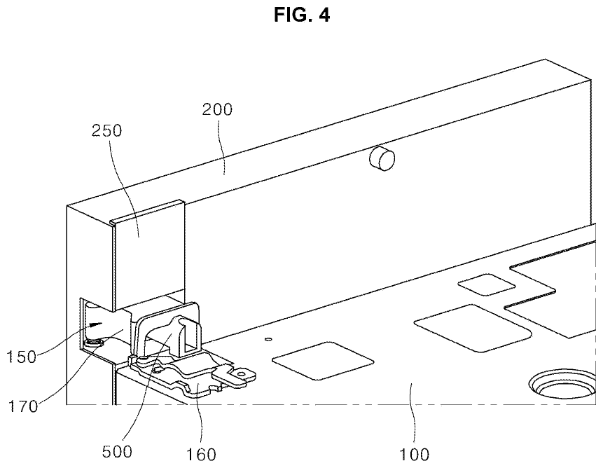

FIG. 1 is a perspective view of a refrigerator of a first embodiment, and FIG. 2 is a plan view of the refrigerator illustrated in FIG. 1. Additionally, FIG. 3 is a plan view of the refrigerator illustrated in FIG. 2 with a door open, and FIG. 4 is a rear perspective view of a portion of the refrigerator illustrated in FIG. 1.

Referring to FIGS. 1 and 2, the exterior of a refrigerator 1 may be formed by a cabinet 100 and a door 210, 220, 230.

The cabinet 100 may have one or more of storage compartments therein, as a storage space of the refrigerator 1. An open front surface of the cabinet 100 may be opened and closed by one or more of doors 210, 220, 230.

The cabinet 100 may comprise an outer case, and an inner case coupled to the inside of the outer case.

The cabinet 100 may be shaped into a box the front surface of which is open. The inner portion of the cabinet 100 may be divided into one or more of storage spaces, and comprise a refrigerator compartment and/or a freezer compartment.

For example, an upper storage compartment opened and closed by a pair of upper doors 210, 220 may be provided in the upper portion of the cabinet 100. Additionally, a lower storage compartment opened and closed by a pair of lower doors 230 may be provided in the lower portion of the cabinet 100.

In the embodiment, a bottom freeze refrigerator is described as an example, and the bottom freeze refrigerator has a refrigerator compartment in the upper portion thereof and has a freezer compartment in the lower portion thereof, as storage compartments in the cabinet 100.

However, the subject matter of the present invention is not limited to the above-described refrigerator, and may comprise various types of refrigerators such as a top freezer refrigerator in which a freezer compartment is mounted on a refrigerator compartment, and a side-by-side refrigerator in which a freezer compartment and a refrigerator compartment are partitioned at the left/right side, and the like.

The door 210, 220, 230 may comprise an upper door 210, 220 and a lower door 230. That is, for the refrigerator of the embodiment, a door 210, 220 for opening and closing the upper storage compartment and a door 230 for opening and closing the lower storage compartment may be provided separately. Further, the door 210, 220 for opening and closing the upper storage compartment and the door 230 for opening and closing the lower storage compartment may be provided in such a way that the doors are divided into a left door and a right door.

However, the subject matter of the present invention may not be limited and may comprise refrigerators provided with various types of doors such as a refrigerator provided with one door for opening and closing a freezer compartment and one door for opening and closing a refrigerator compartment, a refrigerator provided with any one of a door for opening and closing a freezer compartment and a door for opening and closing a refrigerator compartment in such a way that any one door is divided into a left door and a right door, a refrigerator provided with a door for opening and closing a freezer compartment and a door for opening and closing a refrigerator compartment in such a way that the doors are rotatably mounted, a refrigerator provided with a door for opening and closing a freezer compartment and a door for opening and closing a refrigerator compartment in such a way that any one of the doors is mounted to be drawn in the front-rear direction, and the like.

As an example, a first door 210 and a second door 220, as a pair of upper doors 210, 220, may be rotary doors that are rotatably coupled to a pair of hinge assemblies 150 installed respectively at both sides of the cabinet 100. The pair of upper doors 210, 220 may be divided into a first door 210 at the left side of the cabinet, and a second door 220 at the right side of the cabinet.

The pair of upper doors 210, 220, as described above, may open the storage compartment by rotating in a direction where the pair of upper doors 210, 220 becomes far away from each other, while respectively rotating in the lateral direction. For example, the first door 210 disposed at the left side of the refrigerator may open and close the left side of the storage compartment, while rotating around the left end portion of the refrigerator, and the second door 220 disposed at the right side of the refrigerator may open and close the right side of the storage compartment while rotating around the right end portion of the refrigerator.

Additionally, the lower door 230 may also be a rotary door, but not limited. As another example, the lower door 230 may be a drawer door that opens and closes the storage compartment in a sliding manner.

Further, a dispenser 240 may be mounted on any one of the first door 210 and the second door 220. The dispenser 240 may be provided to allow the user to take out drinking water and ice outside the storage compartment of the refrigerator.

In the bottom freezer refrigerator, the upper storage compartment and the lower storage compartment may be divided by a horizontal separation wall disposed between the upper storage compartment and the lower storage compartment. Further, a left space and a right space in the lower storage compartment may be divided by a perpendicular separation wall disposed in the lower storage compartment.

The left space of the lower storage compartment may be opened and closed by the lower door 230 disposed at the left side of the lower storage compartment, and the right space of the lower storage compartment may be opened and closed by the lower door 230 disposed at the right side of the lower storage compartment. That is, the lower door 230 may be provided in such a way that the lower door 230 opens and closes each independent storage space individually.

In the bottom freezer refrigerator, a perpendicular separation wall may not be disposed in the upper storage compartment. That is, in the bottom freezer refrigerator, the left space and the right space in the upper storage compartment may connect as one space without separating into separate spaces.

Since the left space and the right space in the upper storage compartment connect as one space as described above, the upper storage compartment may provide a storage space having a wide entrance and large volume.

However, unless a perpendicular separation wall is not disposed in the upper storage compartment, the airtight performance of the refrigerator may deteriorate while a portion of the upper door 210, 220 does not contact the front surface of the cabinet 100.

For example, in the case where a perpendicular separation wall is disposed in the upper storage compartment, cold air may leak through a gap between the first door 210 and the second door 229 that are blocked by the perpendicular separation wall.

Considering this, a pillar 205 may be installed at the upper door 210, 220. In this embodiment, the pillar 205 is installed at the first door 210, for example.

The pillar 15 may be installed in a lateral portion of the first door 210, preferably, at one side of the first door 210, which faces the second door 220. The pillar 205 may be provided in such a way that the pillar extends in the up-down direction along one side of the first door 210.

The pillar 205, as illustrated in FIG. 2, may remain unfolded in a state where the first door 210 is closed. The unfolded pillar 205 may be disposed between the front surface of the cabinet 100 and the upper door 210, 220 to block between the front surface of the cabinet 100 and the upper door 210, 220 and block a gap between the first door 210 and the second door 220.

The pillar 205, which is unfolded with the upper door 210, 220 closed and blocks a gap between the first door 210 and the second door 220 as described above, may prevent cold air from leaking through the gap between the upper doors 210, 220.

As the first door 210 is opened, the pillar 205 may rotate to be folded toward one side of the first door 210 (see FIG. 3). As the first door 210 is closed, the pillar 205 may rotate to be unfolded (see FIG. 2).

As an example, the pillar 205 may rotate based on an interaction between a cam of a pillar rotation member installed at the upper end of the cabinet 100 and a pillar cam 206 formed at the upper end of the pillar 205.

Additionally, the refrigerator 1, as illustrated in FIGS. 1 and 4, may be provided with a damper assembly 500 that provides a damping force to at least any one of the first door 210 and the second door 220.

In this embodiment, the damper assembly 500 is mounted respectively at the first door 210 and the second door 220, for example.

The damper assembly 500 provides a damping force respectively to the first door 210 and the second door 220 while the first door 210 and the second door 220 are closed, to close the first door 210 and the second door 220 smoothly and reduce a bounce of the first door 210 and the second door 220.

In this embodiment, the structure and operation of the damper assembly 500 are described, in the case where the damper assembly 500 is mounted on the first door 210, for example.

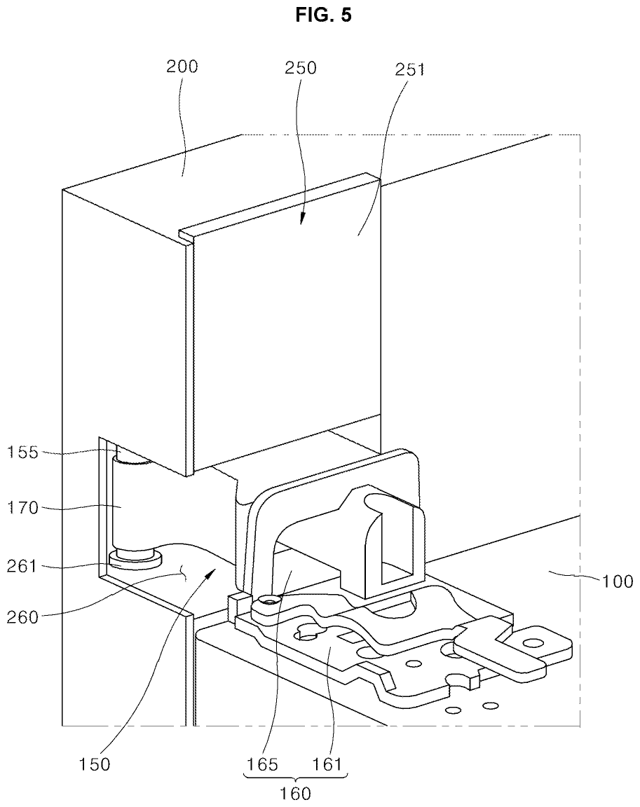

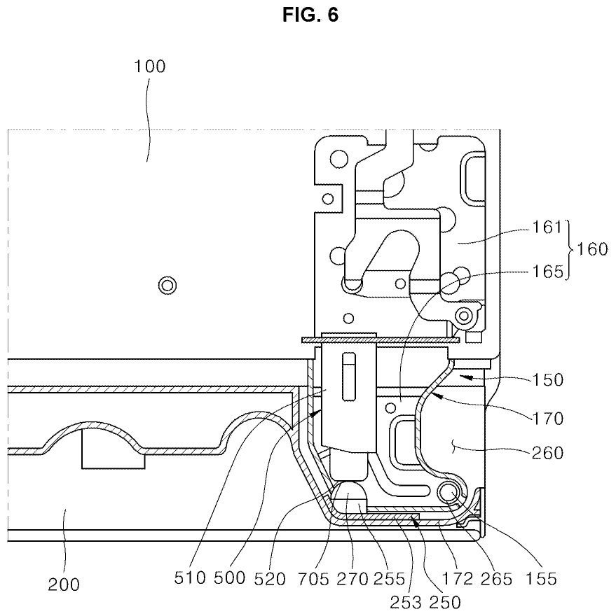

FIG. 5 is an enlarged view of a portion of FIG. 4, and FIG. 6 is a planar cross-sectional view of the inner structures of a damper assembly and a hinge assembly illustrated in FIG. 5.

Referring to FIGS. 3 to 6, the first door 210 and the second door 220 respectively may have a hinge mounting space 260. The hinge mounting space 260 may be disposed respectively at one side of the upper area of the first door 210 and at one side of the upper area of the second door 220, while being formed respectively on the rear surface of the first door 210 and the rear surface of the second door 220.

Hereinafter, any one of the first door 210 and the second door 220 are referred to as the door 200, for example. The door 200 may be any one of the first door 210 or the second door 220 or the third door 230.

The hinge assembly 150 may be inserted into the hinge mounting space 260. A hinge mounting part 261 may be formed in each of the hinge mounting spaces 260. A hinge shaft provided at the hinge assembly 150 may be mounted on the hinge mounting part 261 and provide a rotation axis for the rotation of the door 200.

That is, while at least a portion of the hinge assembly 150 is inserted into the hinge mounting space 260, the hinge assembly 150 may connect to the door 200, and the door 200 may be rotatably installed at the cabinet 100 through the hinge assembly 150. As shown in FIG. 6, a majority of an overall length of the damper assembly 500 extends beyond a front surface of the cabinet 100.

The hinge mounting space 260 may be disposed at a portion adjacent to a lateral surface of the cabinet 100, and have a space large enough for the hinge assembly 150 to be inserted and operated.

In this embodiment, the damper assembly 500 is installed respectively at the first door 210 and the second door 220, for example. Hereinafter, an installation structure of the damper assembly 500 is described in the case where the damper assembly 500 is installed at the second door 220. However, particulars in relation to this may be applied to the damper assembly 500 installed at the first door 210 in the same way.

In this embodiment, the damper assembly 500 may be installed at the hinge assembly 150. To this end, the hinge assembly 150 may have a space into which at least a portion of the damper assembly 500 is inserted, therein.

The damper assembly 500 is inserted into the hinge assembly 150 in the horizontal direction and fixed to the hinge assembly 150. The damper assembly 500 installed as described above may generate a damping force while contacting a hinge assembly 150.

Accordingly, a portion of the damper assembly 500 may move based on contact between the damper assembly 500 and the hinge assembly 150, such that the damper assembly 500 generates a damping force.

The damper assembly 500 may be installed at the hinge assembly 150 in the front-rear direction. That is, the damper assembly 500 may be installed at the first door 210 in the front-rear direction in such a way that a movement axis of the damper assembly 500 is disposed in the front-rear direction.

For example, the damper assembly 500 may be installed at the hinge assembly 150 in such a way that a major axis of the damper assembly 150 extends in the front-rear direction while a minor axis of the damper assembly 150 is disposed in the lateral direction. The damper assembly 500 installed in the front-rear direction, as described above, may generate a damping force while contacting the door 200 disposed at the front side of the damper assembly 500.

At this time, a force applied based on the rotation of the door 200, i.e., a force acting in a direction parallel with a direction in which the door 200 rotates, is applied to the damper assembly 500. Based on the force applied as described above, a force acting in the lateral direction as well as a force acting in the front-rear direction may be applied to the damper assembly 500.

The force applied to the damper assembly 500 in the lateral direction is applied in a direction across the movement axis of the damper assembly 500. Accordingly, a side force acting in the lateral direction of the damper assembly 500 as well as a force applied in the lengthwise direction of the damper assembly 500 may be applied together to the damper assembly 500.

Considering this, in this embodiment, the damper assembly 500 may comprise a damper cover 700 and a damper case 800, in addition to the damper 600.

The damper cover 700 and the damper case 800 may protect the damper 600 from damage to the damper 600 caused by the side force applied by the damper assembly 500, and assist with the movement of the damper 600 to allow a smooth linear movement of the damper assembly 500.

A detailed structure and operation of the damper assembly 500 comprising the damper cover 700 and the damper case 800 are described hereinafter.

### [Schematic Structure of Damper Assembly]

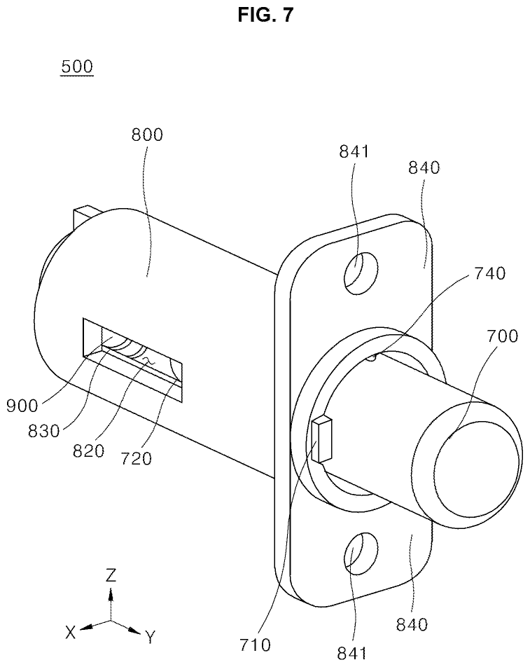

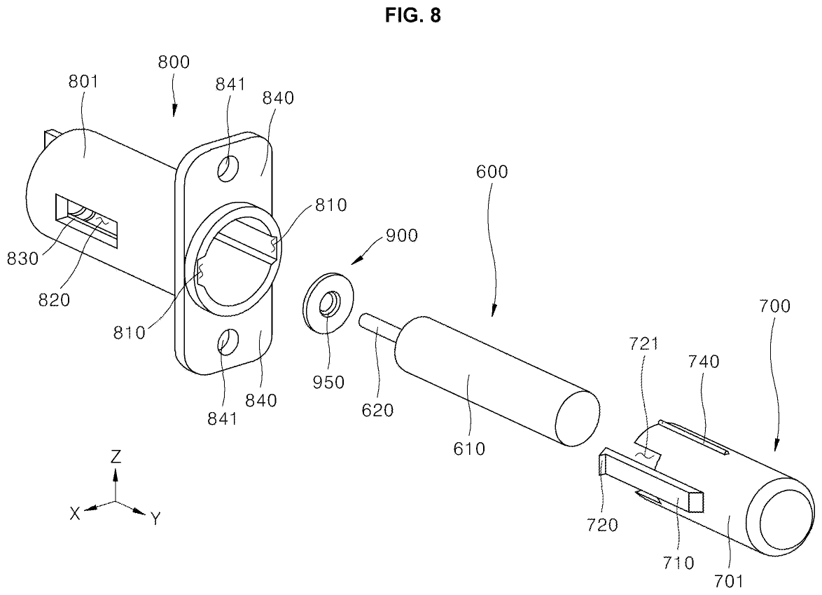

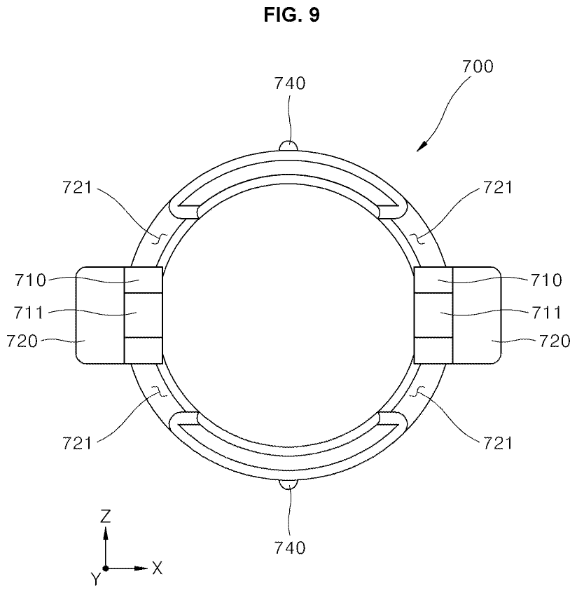

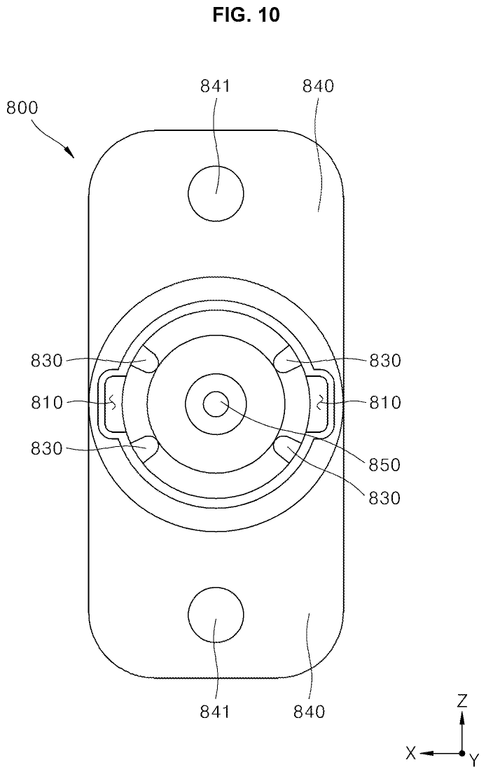

FIG. 7 is a perspective view separately showing the damper assembly illustrated in FIG. 5, and FIG. 8 is an exploded perspective view of an exploded state of the damper assembly illustrated in FIG. 7, and FIG. 9 is a rear view of a damper cover illustrated in FIG. 8. Additionally, FIG. 10 is a front view of a damper case illustrated in FIG. 7.

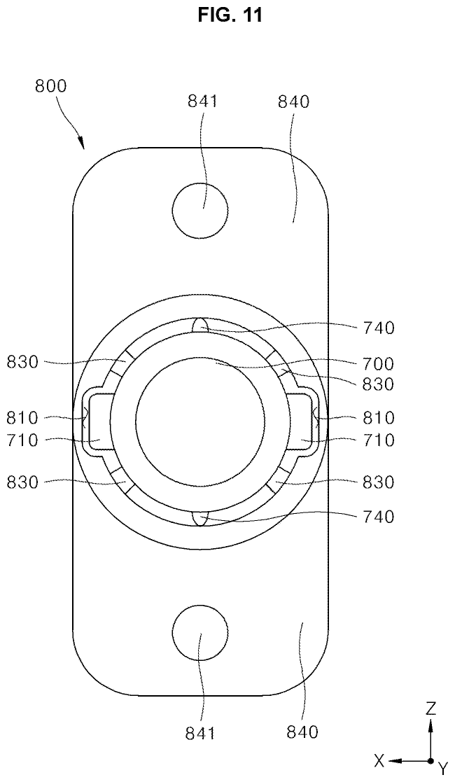

Hereinafter, the structure of the damper assembly 500 in this embodiment is briefly described with reference to FIGS. 7 to 11.

The front-rear direction of the damper assembly 500 described in the present invention may be a direction along the Y-axis, as illustrated in FIG. 7, the up-down direction may be a direction along the Z-axis, and the left-right direction may be the X-axis.

The damper assembly 500 may comprise a damper 600. The damper 600 may substantially perform a damping function at the damper assembly 500. The damper 600 may comprise a housing 610 forming the exterior of the damper 600.

As an example, the housing 610 may be shaped into a cylinder the rear end portion of which is open. A space capable of accommodating various types of components constituting the damper 600 may be formed in the housing 610 provided as described above.

The damper 600 may further comprise a rod 620. The rod 620 may be provided to protrude from the rear end portion of the housing 610.

As an example, the rod 620 may be shaped into a cylindrical rod that extends in the lengthwise direction of the damper 600. The rod 620 may be inserted into the housing 610 through the open rear end portion of the housing 610 and reciprocate along the lengthwise direction of the housing 610.

A piston 670 may be fixed to one side of the rod 620 and placed in the housing 610, and a partial area of the other side of the rod 620 may protrude from the rear end portion of the housing 610.

The piston 670 is specifically described hereinafter.

Since the diameter of the rod 620 is much less than that of the housing 610, that is, the thickness of the rod 620 is not that great, the rod 620 may be easily bent or damaged, making it difficult for the damper 600 to operate properly, in the case where a side force is applied to the damper 600.

Considering this, the damper assembly 500 may further comprise a damper cover 700 and a damper case 800 that are provided to protect the damper 600.

The damper cover 700 may surround the front end portion of the damper 600 and at least a partial area of the outer circumferential surface of the damper 600. Additionally, the damper case 800 may surround the rear end portion of the damper 600 and at least a partial area of the outer circumferential surface of the damper 600.

### [Structures of Damper Cover and Damper Case]

The damper cover 700 may comprise a cover body 701. As an example, the cover body 701 may be shaped into a cylinder the rear end portion of which is open.

A partial area of the damper 600, comprising the front end portion of the damper 600, may be inserted into the cover body 701 through the open rear end portion of the cover body 701. The front end portion of the damper 600, inserted into the cover 700 as described above, may contact the rear surface of the front end portion of the body 701, in the cover 701.

To this end, the inner diameter of the cover body 701 may be greater than the outer diameter of the housing 610.

The cover body 701 may comprise a pair of rail parts 710 that extends in the front-rear direction.

The pair of rail parts 710 may respectively protrude from the outer surface of the cover body 701 outward, to have a predetermined thickness. The pair of rail parts 710 may be disposed respectively at the left and right sides of the outer surface of the cover body 701, to face each other.

The rear end portion of the rail part 710 may protrude further rearward than the rear end portion of the cover body 701. Additionally, the rail part 710 may have a holding part 720, at the rear end portion of the rail part 710.

The holding part 720 may be shaped into a hook. The holding part 720 may restrict the movement of the damper cover 700, based on a hook coupling with the damper case 800, in the case where the damper cover 700 is inserted into the damper case 800.

For example, the front end portion of the holding part 720 may protrude further outward than the rail part 710, to form a step between the front end portion of the holding part 720 and the rail part 710. The front end portion of the holding part 720, formed as described above, may be hook-coupled to a slit part 820 of the damper case 800.

The slit part 820 of the damper case 800 may be additionally described hereinafter.

The rear end portion of the holding part 720 may comprise an inclination surface that slopes downward toward the rear of the holding part 720. The rear end portion of the holding part 720, formed as described above, may guide the damper cover 700 such that the damper cover 700 is easily inserted into the damper case 800.

Additionally, the pair of rail parts 710 may be elastically deformable. For example, the pair of rail parts 710 may be made of an elastic material that may slightly bend in a direction where the pair of rail parts 710 faces each other and then return to an original state. The pair of rail parts 710 provided as described above may help the damper cover 700 to be easily inserted into the damper case 800.

The rail part 710 may have a reinforcement part 711, on the inner surface thereof. The reinforcement part 711 may be formed to extend along the direction where the rail part 710 extends, in the front-rear direction, and reinforce the strength of the rail part 710.

A plurality of insertion parts 721 may be provided on the outer surface of the cover body 701. Each insertion part 721 may be formed at the cover body 701 in such a way that the insertion part 721 is open.

For example, the insertion part 721 may be formed in such a way that a partial area is open from the rear end portion of the cover body 701 to the front thereof. The front end portion of the insertion part 721 may be disposed further forward than the rear end portion of the cover body 701. With respect to one rail part 710, a pair of insertion parts 721 may be respectively disposed at both sides of the rail part 710.

The damper cover 700 may further comprise a first guide rib 740. The first guide rib 740 may protrude from the outer surface of the cover body 701 in the front-rear direction.

A pair of first guide ribs 740 may be disposed on the outer surface of the upper portion of the cover body 701 and on the outer surface of the lower portion of the cover body 701. That is, any one of the pair of first guide ribs 740 may be disposed on the outer surface of the upper portion of the cover body 701, and the other may be disposed on the outer surface of the lower portion of the cover body 701.

Each of the first guide ribs 740 may extend up to a predetermined position in the front-rear direction, in a narrow and long shape, while extending from the rear end portion of the cover body 701 forward.

The first guide rib 740 may operate to prevent the entire outer circumferential surface of the cover body 701 from contacting the inner circumferential surface of the damper case 800, as the damper cover 700 is inserted into the damper case 800 and reciprocates in the front-rear direction.

The first guide rib 740 may guide the reciprocation of the damper cover 700 while decreasing friction that may occur between the cover body 701 of the damper cover 700 and the inner circumferential surface of the damper case 800.

The damper case 800 may be coupled to the damper cover 700, while surrounding at least a partial area of the rear end portion of the damper 600 and at least a partial area of the outer circumferential surface of the damper 600. The damper case 800 may comprise a case body 801.

As an example, the case body 801 may be shaped into a cylinder the front end portion of which is open. A partial area of the damper 600, comprising the rear end portion of the damper 600, may be inserted into the case body 801 through the open front end portion of the case body 801. The rod 620 of the damper 600 inserted into the damper case 800 may be supported by the front surface of the rear end portion of the case body 801, in the case body 801.

To this end, the inner diameter of the case body 801 may be greater than the outer diameter of the housing 610.

The case body 801 may have a case groove 850. The case groove 850 may be formed on the front surface of the rear end portion of the case body 801, in such a way that the case groove 850 is concavely depressed. As an example, the case groove 850 may be shaped into a circle corresponding to the shape of the cross section of the rod 620.

The case groove 850, formed as described above, may effectively restrict a movement of the rod 620 in another direction, i.e., a shake of the rod 620 in the up-down and left-right directions, in addition to a movement of the rod 620 in the front-rear direction as well as guiding a coupling position of the rod 620 relative to the case body 801.

Since the damper 600 is inserted into the damper case 800, in the state of being inserted into the damper cover 700, the case body 801 and the housing 610 of the damper 600 may not contact each other directly. The inner circumferential surface of the case body 801 and the outer circumferential surface of the cover body 701 only may contact each other directly.

To this end, the inner diameter of the case body 801 may be greater than the outer diameter of the housing 610 and the outer diameter of the cover body 701.

A pair of guide parts 810 may be provided on the inner surface of the case body 801. The pair of guide parts 810 may be provided to guide the movement of the pair of rail parts 710 of the damper cover 700.

The guide part 810 may be formed in such a way that the guide part 810 is depressed from the inner circumferential surface of the case body 801 toward the outer circumferential surface of the case body 801. Preferably, the guide part 810 may be concavely formed on the inner circumferential surface of the case body 801, to have a depth corresponding to the thickness of the rail part 710. The guide part 810 may be formed in such a way that the guide part 810 extends from the front end portion of the case body 801 rearward.

A pair of guide parts 810 may be disposed at both sides of the inner surface of the case body 801, to face each other. Each of the rail parts 710 may be inserted into each of the guide parts 810 in a sliding manner. As described above, the rail part 710 inserted into the damper case 800 through the guide part 810 may reciprocate along the guide part 810 in the front-rear direction.

A pair of slit parts 820 may be provided on the lateral surface of the case body 801. The pair of slit parts 820 may be formed in such a way that the slit part 820 penetrates the case body 801 in the lateral direction. Each of the slit parts 820 may be disposed to overlap a partial area of the guide part 810, and disposed in an area that is eccentric rearward from the center of the case body 801 in the front-rear direction.

The holding part 720 of the damper cover 700 may be inserted into the slit part 820 and reciprocate along the slit part 820 in the front-rear direction. Accordingly, the damper cover 700 may be coupled to the damper case 800 in such a way that the damper cover 700 reciprocates in the front-rear direction. Additionally, the damper 600 may be compressed or extended in the front-rear direction together with the front end portion of the damper cover 700 reciprocating as described above.

In the case where the damper 600 extends to a maximum degree, the front end portion of the holding part 720 of the damper cover 700 may be limited by the front end portion of the slit part 820 that is open. Accordingly, an additional movement of the holding part 720 may be limited, and a maximum extension distance of the damper 600 may be controlled to prevent an excessive extension of the damper 600.

A plurality of second guide ribs 830 may be provided on the inner surface of the case body 801. Each of the second guide ribs 830 may protrude from the inner surface of the case body 801 inward, and extend along the front-rear direction.

Each of the second guide ribs 830 may have a width less than that of the first guide rib 810 or the slit part 820, while extending from the rear end portion of the case body 801 forward.

The second guide rib 830 may be formed in such a way that the front end portion of the second guide rib 830 is disposed further rearward than the front end portion of the slit part 820.

In this embodiment, a pair of second guide ribs 830 is disposed respectively on the inner surface of the upper portion of the slit part 820 and the inner surface of the lower portion of the slit part 820, for example. Accordingly, the second guide rib 830 may be respectively disposed at both sides of each slit part 820 in the up-down direction thereof.

The plurality of second guide ribs 830 disposed as described above may reinforce the strength of the case body 801, which is weakened by the slit part 820 that is formed at the case body 801 in such a way that the slit part 820 is open.

Further, the second guide rib 830 may guide the movement of the damper cover 700 inserted into the damper case 800. That is, the second guide rib 830 may guide the movement of the damper cover 700 in such a way that the insertion part 721 of the damper cover 700 reciprocates along the second guide rib 830.

In the case where the damper cover 700 extends, the second guide rib 830 is not inserted into the insertion part 721, but in the case where the damper cover 700 is compressed, a partial area of the second guide rib 830 comprising the front end portion of the second guide rib 830 may be inserted into the insertion part 721.

As a partial area of the second guide rib 830 is inserted into the insertion part 721 as described above, the damper cover 700 may movably engage with the second guide rib 830, and the second guide rib 830 may guide the movement of the damper cover 700.

The case body 801 may further comprise at least one of fastening parts 840. The fastening part 840 may protrude from the outer circumferential surface of the case body 801 outward.

As an example, a pair of fastening parts 840 may be provided at the case body 801, and any one of the pair of fastening parts 840 may protrude to the upper side of the case body 801, and the other may extend to the lower side of the case body 801.

Each fastening part 840 may have a fastening hole 841, and each fastening hole 841 may be formed in such a way that the fastening hole 841 penetrates the fastening part 840 in the front-rear direction.

In the case where the damper assembly 500 is coupled to a fixation target, a fastening member such as a screw may fix the fastening part 840 to the fixation target while passing through the fastening part 840 through the fastening hole 841.

The fastening part 840 may be disposed at a position near the open front end portion of the case body 801. Accordingly, at the case body 801, the size of an area at the front side of the fastening part 840 may be much less than the size of an area at the rear side of the fastening part 840.

As illustrated in FIGS. 5 and 6, the damper assembly 500 may be inserted into a damper assembly mounting part 265 formed to have a predetermined insertion hole.

At this time, an area of the case body 801, disposed at the rear side of the fastening part 840, may be inserted into the damper assembly mounting part 265 and not exposed outward.

Additionally, the fastening part 840 may be coupled to the damper assembly mounting part 265, and accordingly, the damper assembly 500 may be fixed to the rear surface of the first door 210.

Accordingly, a partial area of the case body 801 disposed at the front of the fastening part 840 is only exposed to the outside of the first door 210, and most of the area of the case body 801 is not exposed to the outside of the first door 210 and does not protrude to the outside of the first door 210.

The damper assembly 500 provided as described above may help to increase the spatial availability of the hinge mounting space 260 into which the damper assembly 500 is inserted, and enhance aesthetic qualities of the refrigerator.

A reinforcement plate 900 may be disposed between the damper case 800 and the damper 600, and specifically, between the damper case 800 and the rod 620.

The reinforcement plate 900 may be disposed between the rear end portion of the case body 801 having the case groove 850 and the end portion of the rod 620. The reinforcement plate 900 disposed as described above may support the rod 620 moving toward the rear surface of the damper case 800, between the rear surface of the damper case 800 and the rod 620.

The reinforcement plate 900 may prevent a load applied by the rod 620 from concentrating on a partial area of the rear surface of the damper case 800, to protect the damper case 800, such that the damper case 800 is not damaged due to the load applied by the rod 620.

The reinforcement plate 900 may have a drawn groove 950. The drawn groove 950 may be disposed in a central portion of the reinforcement plate 900, and formed in such a way that the drawn groove 950 is depressed rearward from the front surface of the reinforcement plate 900. Because of the drawn groove 950 formed as described above, a portion of the rear surface of the reinforcement plate 900 may protrude rearward.

Preferably, the drawn groove 950 may be formed to have a shape corresponding to the shape of the cross section of the rod 620. Additionally, the cross section of a protruding portion on the rear surface of the reinforcement plate 900 may have a shape corresponding to the shape of a case groove 850.

Thus, while a portion of the rear surface of the reinforcement plate 900 facing the rear surface portion of the damper case 800 is inserted into the case groove 850, the reinforcement plate 900 may be fixed to the damper case 800.

Additionally, the rod 620 may be inserted into the drawn groove 950, and accordingly, the rod 620 may be fixed to the reinforcement plate 900. Thus, a coupling position of the rod 620 relative to the damper case 800 may be guided by the reinforcement plate 900, and the movement of the rod 620 in the up-down and left-right directions, i.e., a shake of the rod 620 may be effectively restricted by the reinforcement plate 900.

In this embodiment, the damper cover 700 may be inserted into the damper case 800, and reciprocate in the front-rear direction along the inner circumferential surface of the damper case 800.

The movement of the damper cover 700 may depend on the movement of the damper 600.

That is, in the case where the damper 600 is compressed or extended, the damper cover 700 may be compressed or extended along the inner circumferential surface of the damper case 800, together with the damper 600.

In the damper assembly 500 of the embodiment, comprising the damper cover 700 described above, the damper cover 700 and the damper case 800 may protect the damper 600 from the outside. That is, the damper assembly 500 of the embodiment may prevent a side force generated by a structure making a rotation motion from being applied to the damper 600 directly, and accordingly, protect the damper 600 such that the rod 620 of the damper 600 is not bent and damaged.

Further, the damper assembly 500 of the embodiment may assist with the reciprocation of the damper 600 in the front-rear direction, based on a fastening relationship between the damper cover 700 and the damper case 800, and the holding part 720 of the rail part 710, the guide part 810 and the slit part 820.

Thus, the damper assembly 500 of the embodiment may support the damper 600 effectively to ensure a reliable movement of the damper 600 even if a side force generated by a structure making a rotation motion is applied to the damper assembly 500.

Further, in the damper assembly 500 of the embodiment, the damper 600, the damper cover 700 and the damper case 800 may be coupled based on a hook-coupling between the holding part 720 and the slit part 820, formed by an elastic force of the damper 600 itself, without an additional fastening member such as a screw.

The damper assembly 500 may reduce a man hour for assembly, ensure efficient assembly processing, and decrease costs incurred for manufacturing the damper assembly 500.

### [Structure of Damper]

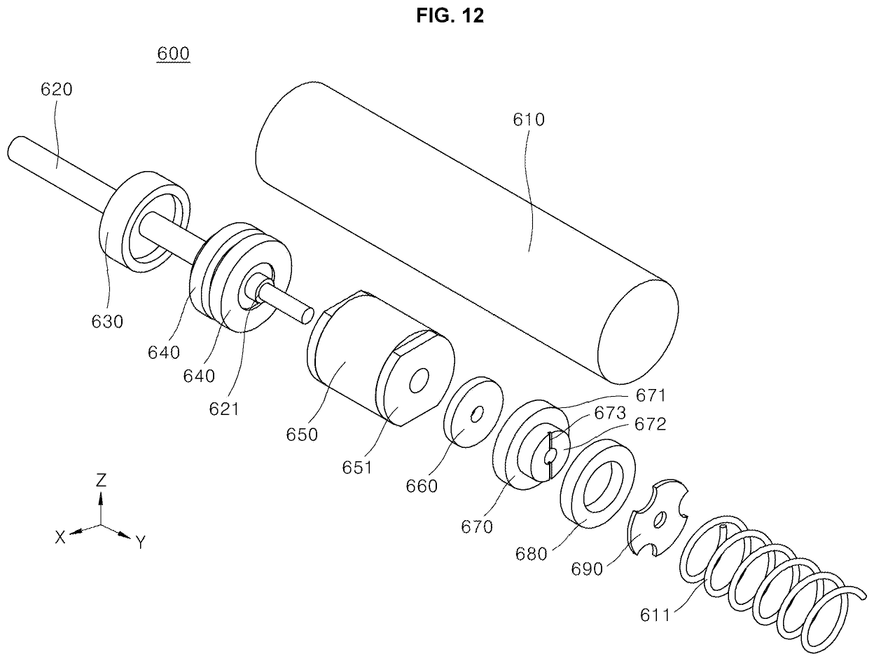

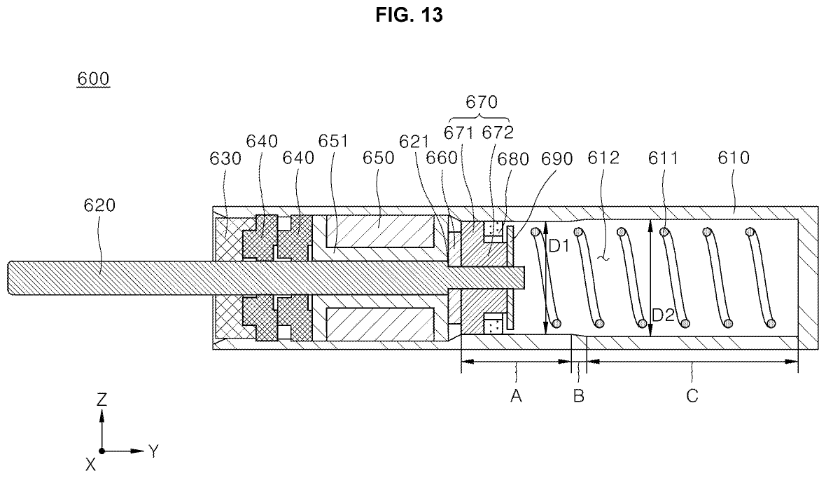

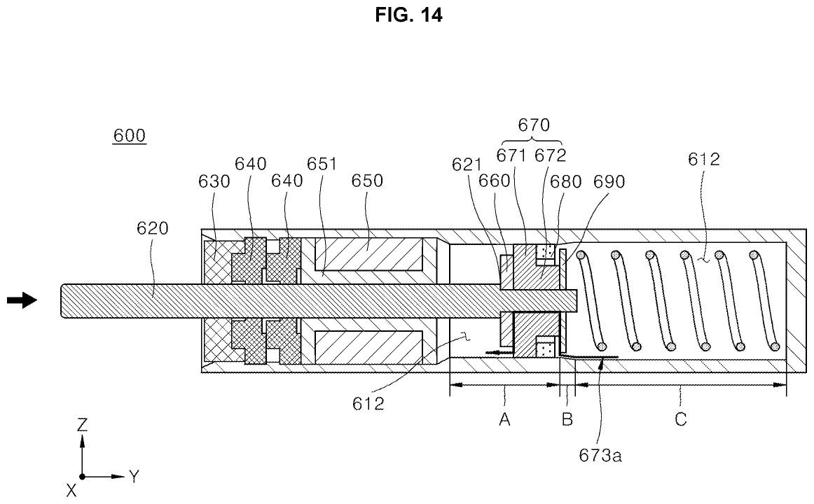

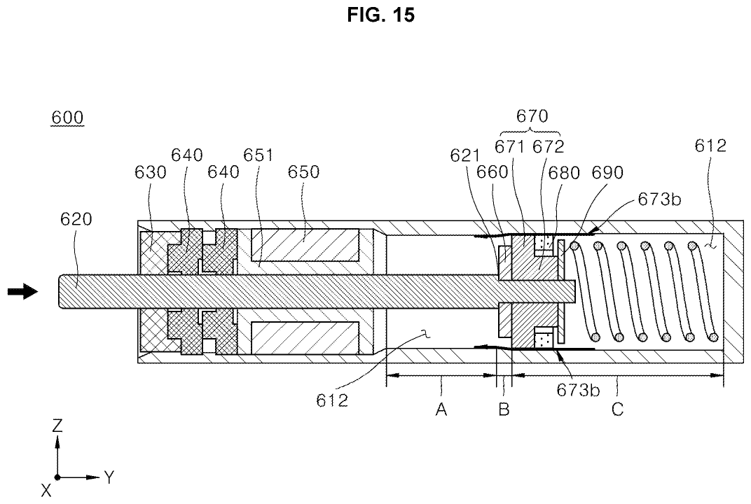

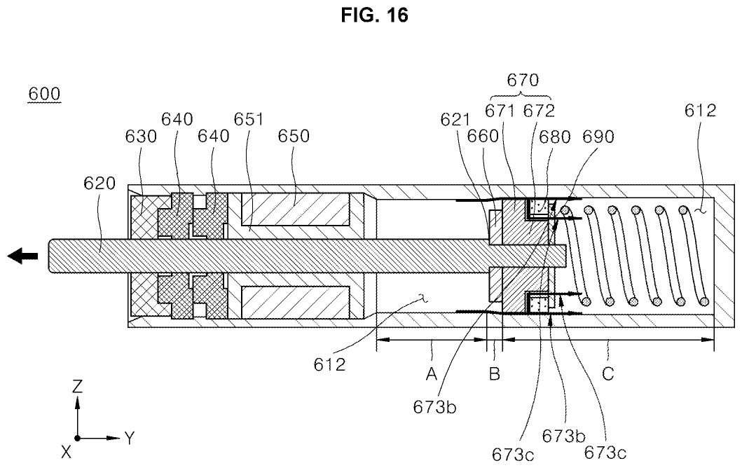

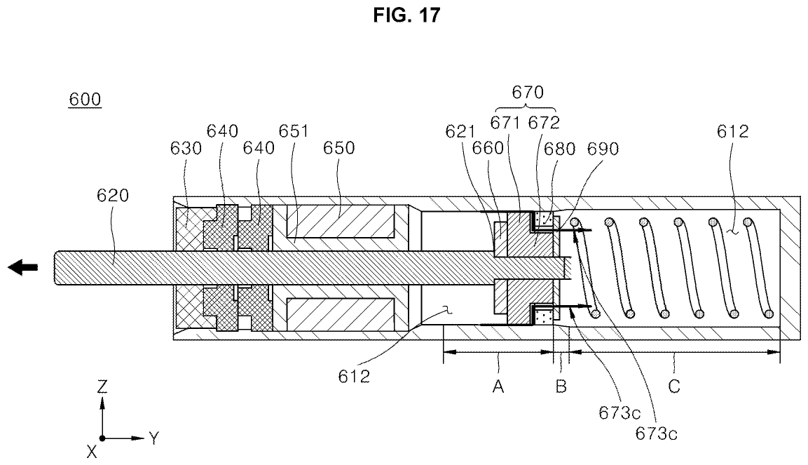

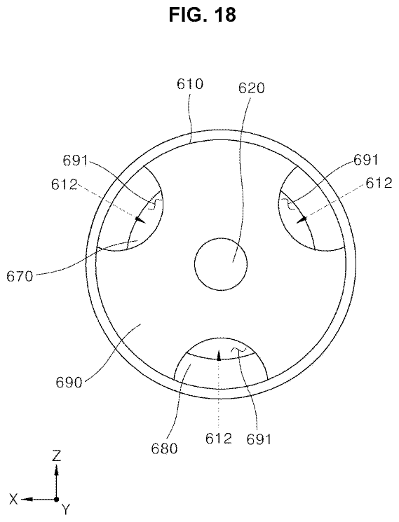

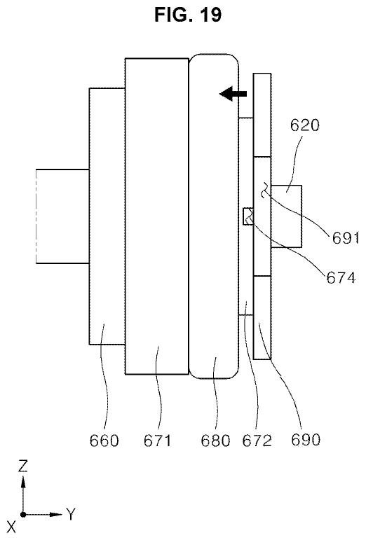

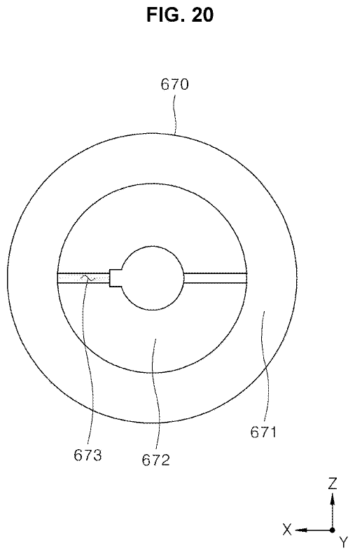

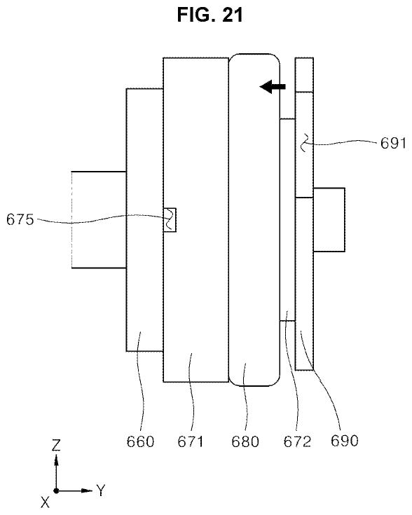

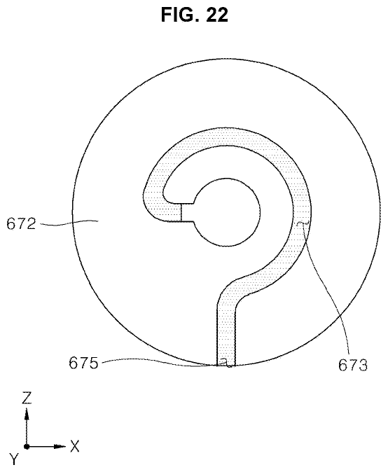

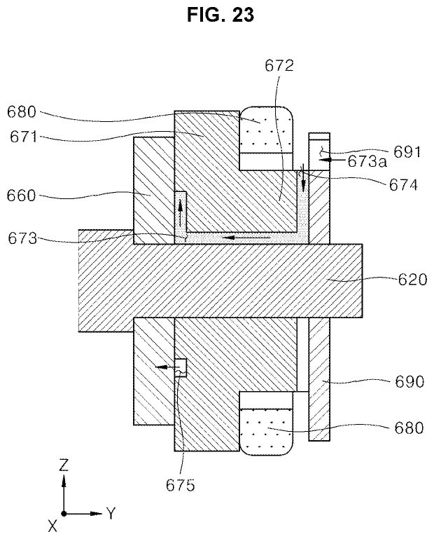

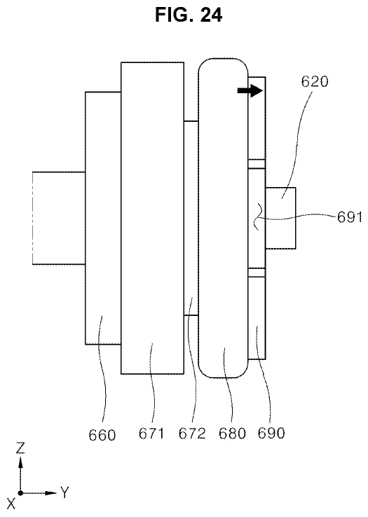

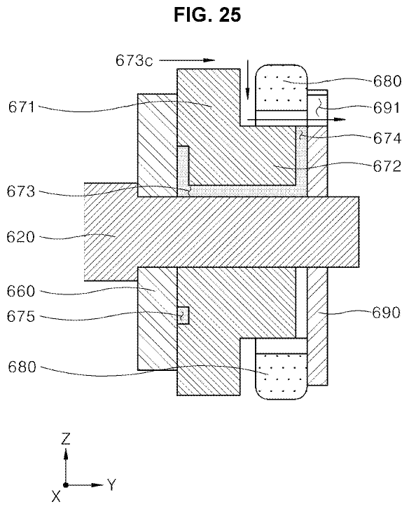

FIG. 12 is an exploded perspective view of an exploded state of a damper illustrated in FIG. 7, and FIG. 13 is a lateral cross-sectional view of the inner structure of the damper illustrated in FIG. 12. FIGS. 14 and 15 are lateral cross-sectional views of a compressed state of the damper illustrated in FIG. 13, and FIGS. 16 and 17 are lateral cross-sectional views of a return state of the damper illustrated in FIG. 15. FIG. 18 is a front cross-sectional view of a damper for showing an oil inflow path in the damper, and FIG. 19 is a view of an inlet of oil in a state where a ring contacts a first piston part. FIG. 20 is a rear view of a piston illustrated in FIG. 19, FIG. 21 is a side view of an outlet of oil in a state where a ring contacts a first piston part, and FIG. 22 is a front view of a piston illustrated in FIG. 21. FIG. 23 is a lateral cross-sectional view of a damper for showing an oil flow path part in a state where a ring contacts a first piston part, FIG. 24 is a side view of a return state of a damper, and FIG. 25 is a lateral cross-sectional view of the damper illustrated in FIG. 24.

Hereinafter, the structure of the damper 600 of the embodiment is described specifically with reference to FIGS. 12 to 25.

Referring to FIG. 12, the damper 600 may comprise a housing 610 forming the exterior of the damper 600. Additionally, the damper 600 may further comprise a guide 630, a sealer 640, a sponge 650, a sponge cover 651, a washer 660, a piston 670, a ring 680 and a bracket 690 that are accommodated in the housing 610.

In the housing 610, the guide 630, the sealer 640, the sponge 650, the sponge cover 651, the washer 660, the piston 670, the ring 680 and the bracket 690 may be coupled to the rod 620.

In this embodiment, the guide 630, the sealer 640, the sponge 650, the sponge cover 651, the washer 660, the piston 670, the ring 680 and the bracket 690 may be coupled to the rod 620 in such a way that central portions of the guide 630, the sealer 640, the sponge 650, the sponge cover 651, the washer 660, the piston 670, the ring 680 and the bracket 690 are penetrated by the rod 620, for example.

As described above, the housing 610 may have a space that accommodates the guide 630, the sealer 640, the sponge 650, the sponge cover 651, the washer 660, the piston 670, the ring 680 and the bracket 690, therein. Additionally, the housing 610 may have a cylinder space charged with oil 612, therein.

The guide 630 may be disposed closest to the open rear end portion of the housing 610 than any other component accommodated in the housing 610. The guide 620 may prevent the other components in the housing 610 from escaping out of the housing 610.

Additionally, the guide 620 may also hold the rod 620 to prevent the rod 620 from shaking in the up-down and left-right directions at a time of reciprocal-translational motion of the rod 620. As an example, the guide 630 may be made of a plastic material. Preferably, the guide 630 may be made of a polyamide nylon resin material.

The sealer 640 may be disposed at the front of the guide 630. The sealer 640 prevents the oil 612 in the housing 610 from leaking outward, and substantially seal the housing 610.

The inner circumferential surface of the sealer 640 may contact the rod 620 directly, and the outer circumferential surface of the sealer 640 may contact the inner circumferential surface of the housing 610 directly. The sealer 640 disposed between the rod 620 and the housing 610 as described above may block a gap through which the oil 612 leaks out of the housing 610.

A plurality of sealers 640 may be disposed in the housing 610. The plurality of sealers 640 may be arranged in the housing 610 in the front-rear direction. The plurality of sealers 640 may be provided to promote a leakage prevention effect further.

As an example, the sealer 640 may be made of an oil-resistant rubber. Preferably, the sealer 640 may be made of a nitrile butadiene rubber material (NBR).

The sponge 650 may be disposed at the rear of the sealer 640. That is, the sponge 650 may be disposed between the sealer 640 and the piston 670. The sponge 650 may compensate the volume of a space between the sponge 650 and the piston 670, such that the oil 612 moves in a direction opposite to the direction where the piston 670 moves forward as the damper 600 is compressed.

The sponge 650 may be made of a porous material, and the sponge 650 may be compressed by oil that flows into the space between the sponge 650 and the piston 670 as the damper 600 is compressed. The compressed sponge 650 may expand the space between the sponge 650 and the piston 670.

As an example, the sponge 650 may be made of a plastic material. Preferably, the sponge 650 may be made of a synthetic resin material.

The sponge cover 651 may be disposed between the rod 620 and the sponge 650. The sponge cover 651 may be fitted to the outer circumferential surface of the rod 620, and the sponge 650 may be installed at the sponge cover 651 in such a way that the sponge 650 surrounds the circumference of the sponge cover 651.

The sponge cover 651 may be an elastically deformable material. For example, the sponge cover 651 may be made of a plastic material. Preferably, the sponge cover 651 may be made of a polyoxymethylene (POM) material.

The sponge cover 651 may support the sponge 650 such that the sponge 650 is compressed at a time of compression of the damper 600 while the sponge returns to an original state at a time of return of the damper 600.

The washer 660 may be disposed between the sponge 650 and the piston 670. The washer 660 may promote a fastening effect between the rod 620 and the piston 670 while supporting the piston 670 at the front of the piston 670.

The front surface of the washer 660 may contact the rod 620 directly such that the front surface of the washer 660 is held and coupled to a step part 621 where the diameter of the rod 620 decreases.

The rear surface of the washer 660 may contact the front surface of the piston 670 directly, and form a flow path in which the oil 612 flows together with the piston 670. In this embodiment, the washer 660 contacts the front surface of a first piston part 671 of the piston 670, for example.

The washer 660 may be made of a metallic material. As an example, the washer 660 may be made with a steel plate cold commercial (SPCC).

The piston 670 may be disposed at the front sides of the sponge 650 and the washer 660. At least a portion of an oil flow path part may be provided at the piston 670, as illustrated in FIGS. 12, 19 and 21. The oil flow path part may form a passage required for the oil 612 to pass through the piston 670 and flow, on the piston 670, as the damper 600 is compressed.

As an example, the piston 670 may be made of a plastic material. Preferably, the piston 670 may be made of a polyamide nylon resin material.

The piston 670 may comprise a first piston part 671 and a second piston part 672 that are arranged in the front-rear direction. The second piston part 672 may protrude from the first piston part 671 forward, and the outer diameter of the second piston part 672 may be less than the outer diameter of the first piston part 671.

The bracket 690 may be disposed at the front of the piston 670. The bracket 690 may be disposed to face the second piston part 672.

The rod 620 may protrude to the front sides of the piston 670 and the bracket 690 by passing through the piston 670 and the bracket 690. The end portion of the rod 620 protruding as described above may be rivet-processed, and the piston 670 may be fixed to the rod 620 not to escape from the rod 620.

The bracket 690 may be disposed between the rivet-processed end portion of the rod 620 and the piston 670, such that the piston 670 is protected during rivet-processing for fixing the piston 670.

One surface of the bracket 690 may touch and contact one surface of the second piston part 672 of the piston 670, and form a flow path in which the oil 612 flows together with the piston 670.

As illustrated in FIGS. 12 and 17, a plurality of drawn parts 691 may be provided at the bracket 690. Each of the drawn parts 691 may be formed in such a way that the drawn part penetrates the bracket 690 in the front-rear direction. The plurality of drawn parts 691 may be disposed at the bracket 690 in such a way that the drawn parts 691 are spaced a predetermined distance apart from each other along a circumferential direction of the bracket 690. The oil 612 may flow through a passage formed by the drawn part 691 while passing through the bracket 690.

The bracket 690 may be made of a metallic material. As an example, the bracket 690 may be made with a steel plate cold commercial (SPCC).

A ring 680 may be disposed between the piston 670 and the bracket 690, as illustrated in FIGS. 12 and 18.

The ring 680 may be disposed between the inner circumferential surface of the housing 610 and the piston 670. The outer circumferential surface of the ring 680 may contact the inner circumferential surfaces of the housing 610, to seal between the ring 680 and the housing 610.

That is, the ring 680 may block the oil from flowing through a gap between the outer circumferential surface of the ring 680 and the inner circumferential surface of the housing 610.

In this embodiment, the ring 680 and the housing 610 contact each other closely in a first inner diameter section A described hereinafter, to seal between the ring 680 and the housing 610, for example.

The ring 680 may be disposed outside the piston 670, specifically, the second piston part 672, in a diametrical direction thereof. The inner diameter of the ring 680 may be greater than the outer diameter of the second piston part 672.

The ring 680 formed as described above may be spaced a predetermined distance apart from the outer circumferential surface of the second piston part 672 and surround the second piston part 672 from the outside thereof, in the diametrical direction thereof. Accordingly, an oil return passage 681 may be formed between the inner circumferential surface of the ring 680 and the outer circumferential surface of the second piston part 672. The oil return passage 681 may provide a passage allowing the oil 612 to pass through the ring 680 and flow.

Additionally, the ring 680 may be disposed between the first piston part 671 and the bracket 690. A front-rear thickness of the ring 680 may be less than a front-rear thickness of the second piston part 672 disposed between the first piston part 671 and the bracket 690. The ring 680 formed as described above may reciprocate between the first piston part 671 and the bracket 690, in the front-rear direction, along the second piston part 672.

For example, the ring 680 may move toward the first piston part 671 as the damper 600 is compressed. Accordingly, the ring 680 may contact the first piston part 671 closely, to seal between the first piston part 671 and the ring 680, and be spaced from the bracket 690.

As sealing is done between the first piston part 671 and the ring 680 as described above, the oil 612 may not flow through the oil return passage 681, and the flow of the oil 612 may be induced such that the oil 612 only may flow through the oil flow path part provided at the piston 670.

As the damper 600 returns, the ring 680 may move toward the bracket 690. Accordingly, the ring 680 may be spaced from the first piston part 671 and open between the first piston part 671 and the ring 680. As opening is done between the first piston part 671 and the ring 680 as described above, the oil 612 may flow through the oil return passage 681.

In this embodiment, an inner diameter change section B may be in the damper 600, and the ring 680 repeats passing through the inner diameter change section B while the damper 600 is compressed and returned repeatedly.

As the ring 680 passes through the inner diameter change section B, a strong impact may be applied to the ring 680, and as the ring 680 is formed to provide a strong sealing force, frictional resistance applied to the ring 680 increases. In the case where a strong impact and frictional force are repeatedly applied to the ring 680 as described above, the sealing force of the ring 680 decreases, and the possibility of damage to the ring 680 increases.

Considering this, a ring 680 made of a material having a higher strength and a lower friction coefficient than the sealer 640 is provided in this embodiment.

Such a ring 680 may be made of a plastic material. As an example, the ring 680 may be made of fluorine resin. Preferably, the ring 680 may be made of a Teflon material.

More preferably, the ring 680 may be formed in such a way that carbon is contained in Teflon at 10% to 30% with respect to its entire weight.

Teflon exhibits higher strength and lower frictional resistance than rubber. In the case where the ring 680 is made of a Teflon material, the ring 80 may have high durability, and friction resistance applied to the ring 680 may decrease, compared to a ring made of rubber.

The sealing force of the ring 680 may be less than that of a ring made of rubber, but an effect caused by a difference between the sealing force of the ring 680 and the sealing force of the ring made of rubber may be sufficiently offset by the sealer 640 that is provided apart from the ring 680.

Unlike the ring 680, the sealer 640 is not a member that rubs against the housing 610 while moving in the housing 610 and passes through the inner diameter change section B.

That is, the sealer 640 is less affected by a strong impact and frictional resistance then the ring 680. The sealer 640 may compensate a sealing force provided by the ring 680 by providing a sufficiently high sealing force since the sealer 640 is made of rubber.

Thus, the ring 680 made of a material ensuring high durability and low frictional resistance may be disposed in an area that is affected by a strong impact and frictional resistance, and the sealer 640 made of a material providing a high sealing force may be disposed in an area that is relatively free from a strong impact and frictional resistance.

A combination of the sealer 640 and the ring 680 described above helps to provide a sufficiently effective sealing force and protect the ring 680 from damage, ensuring improvement in reliability of repetition of the damper 600.

Additionally, the ring 680 made of a Teflon material, in this embodiment, may reduce friction between the ring 680 reciprocating along the inner circumferential surface of the housing 610 and the housing 610, such that the damper 600 may operate naturally and smoothly without stopping.

The ring 680 in this embodiment may be made of a material having a higher elastic modulus than the material for the sealer 640. For example, the ring 680 in this embodiment may be made of a Teflon material having a higher elastic modulus than rubber. The shape of the ring 680 made of such a material is less deformable than that of the sealer 640.

The ring 680 may contact the housing 610 solidly in a damping section, but there is almost no change in the shape of the ring 680 in a non-damping section despite oil pressure, and the ring 680 does not contact the housing 610.

If similar to the sealer 640, the ring is made of a rubber material easily deformable, the shape of the ring may be easily deformable because of oil pressure, as the piston 670 compresses oil. At this time, a change in the shape of the ring may be made in such a way that the size of the ring increases in the centrifugal direction.

At this time, as the ring enters into the non-damping section, the shape of the ring changes, and accordingly, a change in the surface area of the flow path is delayed at a time of transition from the damping section to the non-damping section, and a transition to the non-damping section is delayed.

However, the ring 680 in this embodiment is made of a material that is not easily deformable, such that a transition from the damping section to the non-damping section is performed readily.

The rod 620 may be shaped into a long thin rod that extends in the front-rear direction. The rod 620 may extend rearward from the piston 670 and move together with the piston 670 in the front-rear direction.

The rod 620 may be made of a metallic material. For example, the rod 620 may be made of stainless steel.

The rod 620 may have a step part 621. The step part 621 may be formed in such a way that the inner diameter of the step part 621 is less than the inner diameter of another portion of the rod 620. The step part 621 may be disposed in an area of the rod 620 eccentric to the front thereof.

The guide 630, the sealer 640, the sponge 650 and the sponge cover 651 may be disposed at the rear of the step part 621. They may be fixed in the housing 610 without being affected by the reciprocation of the rod 620.

However, the washer 660, the piston 670, the ring 680 and the bracket 690 may be disposed at the front of the step part 621. They may move in the housing 610, together with the rod 620.

The damper 600 may further comprise an elastic member 611. The elastic member 611 may be accommodated in the housing 610, and disposed between the front end portion of the housing 610 and the bracket 690.

As an example, the elastic member 611 may be a coil spring the rear end portion of which is supported by the front end portion of the housing 610 and the front end portion of which supports the bracket 690. The elastic member 611 may provide an elastic force of returning the piston 670 having moved in a direction where the oil 612 is compressed.

The damper 600 may comprise a first inner diameter section A, a second inner diameter section C, an inner diameter change section B disposed between the first inner diameter section A and the second inner diameter section C. That is, the inside of the housing 610 may be divided into the first inner diameter section A, the inner diameter change section B and the second inner diameter section C.

The inner diameter D2 of the housing 610 in the second inner diameter section C may be greater than the inner diameter D1 of the housing 610 in the first inner diameter section A.

In the inner diameter change section B, the inner diameter of the housing 610 may continue to decrease or increase in one direction. That is, in the inner diameter change section C, an inclination surface may be formed on the inner circumferential surface of the housing 610.

Since the housing 610 has sections having a different inner diameter as described above, one damper 600 may provide various types of damper forces.

For example, a first damping force provided by the damper 600 in a first damping force section A may be greater than a second damping force provided by the damper 600 in a second damping force section C.

As an example, the first damping force section A may be a damping section in which the damper 600 provides a damping force, and the second damping force section C may be a non-damping section in which the damper 600 provides no damping force, or in which the damping section is transitioned to the non-damping section as the damper 600 is compressed.

As the damper 600 is compressed, the outer circumferential surface of the ring 680 may contact the inner circumferential surface of the housing 610 closely in the first damping force section A, such that the ring 680 blocks between the ring 680 and the housing 610.

As a gap between the ring 680 and the housing 610 is blocked by the ring 680, the oil 612 may flow only through the oil flow path part of the piston 670, and the damper 600 may provide the first damping force.

In the case where the ring 680 enters into the non-damping section, i.e., the second damping force section B, past the damping section, as the damper 600 continues to be compressed, a gap is generated between the ring 680 and the inner circumferential surface of the housing 610.

Accordingly, the oil 612 may flow through the gap between the ring 680 and the inner circumferential surface of the housing 610 as well as the oil flow path part of the piston 670.

The gap between the ring 680 and the housing 610 may form a passage that has lower flow resistance than the passage in the piston 670. Additionally, since the oil 612 flows through both of the passage formed by the gap and the oil flow path part of the piston 670, flow resistance in the second damping force section B may become much less than flow resistance in the first damping force section A.

Thus, in the second damping force section B, a damping force provided by the damper 600 becomes very low, thereby producing a non-damping effect.

The damper 600 in this embodiment may adjust a damping force in stages, in the case where the damper 600 is compressed, based on a difference in the inner diameter of the housing 610 through a step.

The damper 600 may readily provide a damping force in stages without causing large costs based on a simple process in which the inner shape of the housing 610 changes slightly, rather than a complex and expensive process in which the viscosity of oil 612 varies in each section or in which the diameter of the oil flow path part of a piston 670 varies in each section.

### [Operation Structure of Damper]

Hereinafter, the operation structure of the damper 600 is described specifically.

Referring to FIGS. 19 and 23, the second piston part 672 may have an inlet 674. The inlet 674 may be provided in a groove shape that is concavely formed on the front surface the second piston part 672.

The inlet 672 formed as described above may extend toward the open center of the piston 670, and extend rearward along the inner circumferential surface of the piston 670 at the open center of the piston 670. The inlet 672 may extend to a position where the inlet 672 connects to the rear surface of the piston 670.

The first piston part 671 may have an outlet 675. The outlet 675 may be provided in a groove shape that is concavely formed on the rear surface of the first piston part 671.

The oil 612 having flown into the inlet 674 and then having passed through the piston 670 through the open center of the piston 670 may be discharged out of the piston 670 through the outlet 675.

Referring to FIGS. 14, 15 and 23, the oil flow path part in this embodiment may comprise a first flow path 673a. The first flow path 673a may provide a path comprising the drawn part 691 formed at the bracket 690, the space formed between the drawn part 691 and the ring 680, the inlet 674 and the outlet 675.

The first flow path 673a may provide a path comprising the drawn part 691 formed at the bracket 690, the space formed between the drawn part 691 and the ring 680, the inlet 674 and the outlet 675.

For example, in the first flow path 673a, the oil 612 may pass through the bracket 690 through the drawn part 691, flow into the space formed between the drawn part 691 and the ring 680 and then be drawn between the second piston part 672 and the bracket 690 through the inlet 674.

As described above, the oil 612 drawn between the second piston part 672 and the bracket 690 may flow into the outlet 675 through a passage formed between the rod 620 penetrating the center of the piston 670 and the piston 670.

The oil 612 having flown into the outlet 675 may flow through a passage formed between the first piston part 671 and the washer 660 and then be discharged to the rear side of the piston 670.

As the entire length of the first flow path 673a increases, a deviation from the damping force of the damper 600 may decrease. To minimize the deviation from the damping force of the damper 600, the first flow path 673a is preferably designed to make the longest detour.

To this end, in this embodiment, the outlet 675 may be shaped to comprise a section in which the outlet 675 extends along the circumferential direction of the piston 670, as illustrated in FIGS. 21 and 22.

As an example, the outlet 675 may be divided into three sections. A first section of the outlet 675 is a section connecting to the open center of the piston 670, i.e., a section connecting to the inlet 674. The first section of the outlet 675 may be formed in such a way that the first section extends at the open center of the piston 670 in the centrifugal direction.

A third section of the outlet 675 is a section connecting to the outside of the first piston part 671 in the diametrical direction thereof, i.e., a section in which the outlet 675 is exposed outward in the diametrical direction of the piston 670. The third section of the outlet 675 may be formed in such a way that the third section extends from the outer circumferential surface of the first piston part 671 in the centripetal direction thereof.

A second section of the outlet 675 is a section connecting between the first section and the third section of the outlet 675. The second section of the outlet 675 may be formed in such a way that the second section extends along the circumferential direction of the piston 670. That is, the second section of the outlet 675 may extend in such a way that the second section detours in a round manner, around the open center of the piston 670, along the circumferential direction of the piston 670, rather than connecting between the first section and the third section of the outlet 675 linearly.

Thanks to the second section of the outlet 675 formed described above, the entire length of the outlet 675 may extend effectively. Accordingly, the entire length of the first flow path 673a increases, and a deviation from the damping force of the damper 600 may decease effectively.

Referring to FIGS. 14 and 23, the rod 620 and the piston 670 may move forward as the damper 600 is compressed. As the rod 620 and the piston 670 move forward, the ring 680 may contact the first piston part 671 closely.

Because of a frictional force acting between the inner circumferential surface of the housing 610 and the ring 680, the position of the ring 680 may be maintained until the ring 680 contacts the first piston part 671. In the case where the piston 670 continues to move forward in the state where the ring 680 contacts the first piston part 671, the ring 680 may move forward together with the piston 670.

While the piston 670 compresses the oil 612 and the ring 680 moves in the first inner diameter section A, the oil 612 in a space disposed further forward than the piston 670, i.e., a space between the anterior portion of the housing 610 and the piston 670 (hereinafter, “anterior space”), may pass through the piston 670 through the first flow path 673a and flow to a space between the piston 670 and the sponge 650 (hereinafter, “posterior space”).

The oil flow path part in this embodiment, as illustrated in FIGS. 15 and 16, may further comprise a second flow path 673b. The second flow path 673b may provide a path comprising a path between the outer circumferential surface of the first piston part 671 and the inner circumferential surface of the housing 620, and a path between the outer circumferential surface of the ring 680 and the inner circumferential surface of the housing 610.

For example, in the second flow path 673b, the oil 612 may flow forward or rearward by consecutively passing through a path between the outer circumferential surface of the first piston part 671 and the inner circumferential surface of the housing 620 and between the outer circumferential surface of the ring 680 and the inner circumferential surface of the housing 610.

As an example, as illustrated in FIG. 15, while the piston 670 compresses the oil 612 and the ring 680 moves in the second inner diameter section C, the oil 612 in the anterior space may flow rearward while passing through the piston 670 though the second flow path 673b.

Since the inner diameter of the housing 610 in the second inner diameter section C is greater than in the first inner diameter section A, a gap is created between the outer circumferential surface of the ring 680 and the inner circumferential surface of the housing 610. The gap between the ring 680 and the housing 610 in the second flow path 673b may form a passage having lower flow resistance than in the first flow path part 673a.

That is, the second flow path 673b may form a passage having lower flow resistance than the first flow path 673a, such that the oil 612 may flow in the second flow path 673b rather than the first flow path 673a.

Additionally, the oil flow path part in this embodiment may further comprise a third flow path 673c as illustrated in FIGS. 16, 17 and 25. The third flow path 673c may provide a path comprising a path between the outer circumferential surface of the first piston part 671 and the inner circumferential surface of the housing 620, the oil return passage 681 and the drawn part 691.

For example, in the third flow path 673c, the oil 612 may flow forward by consecutively passing through a path between the outer circumferential surface of the first piston part 671 and the inner circumferential surface of the housing 620, the oil return passage 681 and the drawn part 691.

As the piston 670 returns, that is, the piston 670 moves forward, the bracket 690 may move forward together with the piston 670. Because of a frictional force acting between the inner circumferential surface of the housing 610 and the ring 680, the position of the ring 680 may be maintained until the ring 680 contacts the bracket 690.

After the ring 680 contacts the bracket 690, the ring 680 may move forward together with the piston 670 and the bracket 690. In this process, the ring 680 may be spaced from the first piston part 671 and open between the first piston part 671 and the ring 680. As opening is done between the first piston part 671 and the ring 680, the oil 612 may flow through the oil return passage 681.

As illustrated in FIGS. 16, 24 and 25, while the piston 670 returns and the ring 680 moves in the second inner diameter section C, the oil 612 in the posterior space may flow forward while passing through the piston 670 through the third flow path 673c.

Referring to FIGS. 17, 24 and 25, while the piston 670 returns and the ring 680 passes through the first inner diameter section A, the ring 680 and the housing 610 contact each other closely, and the gap between the outer circumferential surface of the ring 680 and the inner circumferential surface of the housing 610 disappears.

Thus, the second flow path 673b is blocked, and the oil 612 in the posterior space may pass through the piston 670 through the third flow path 673c and flow to the anterior space.

### [Structures of Hinge Assembly and Door Cover]

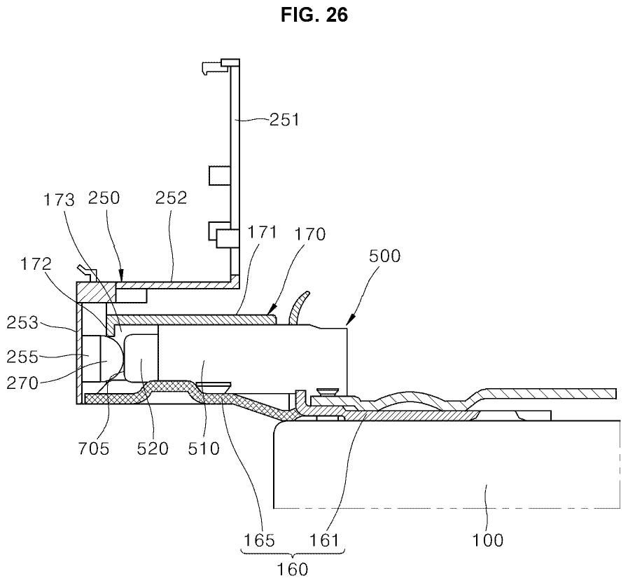

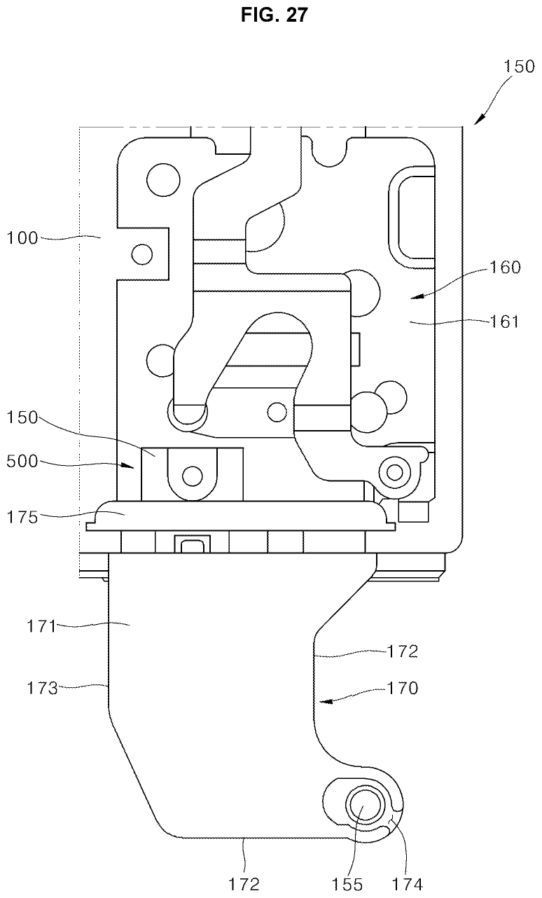

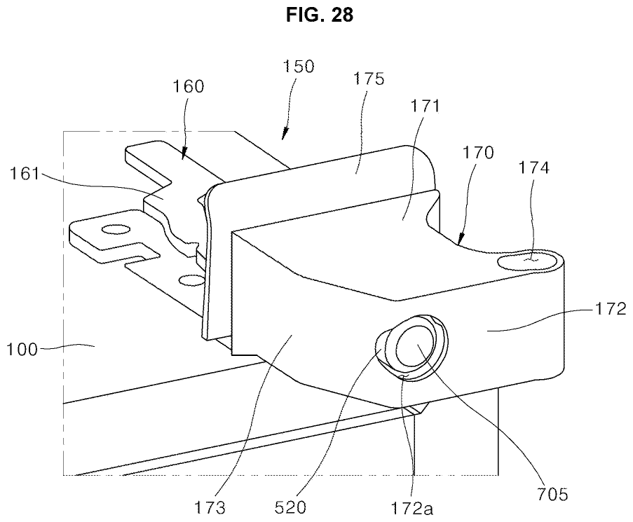

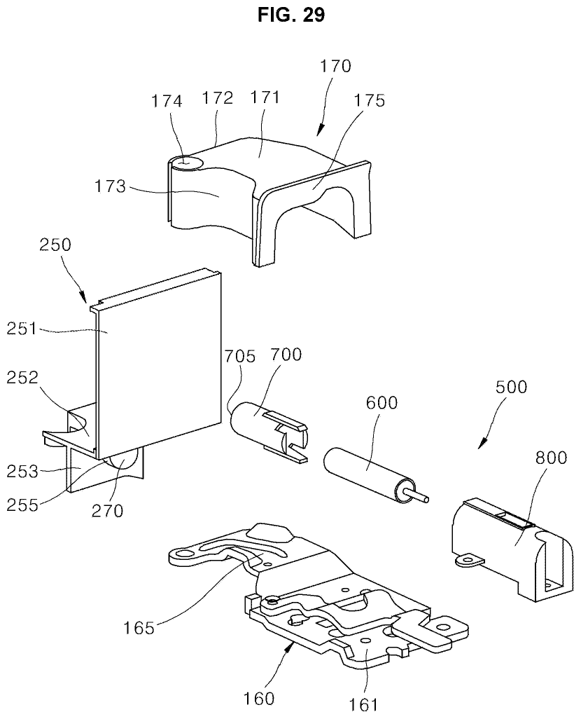

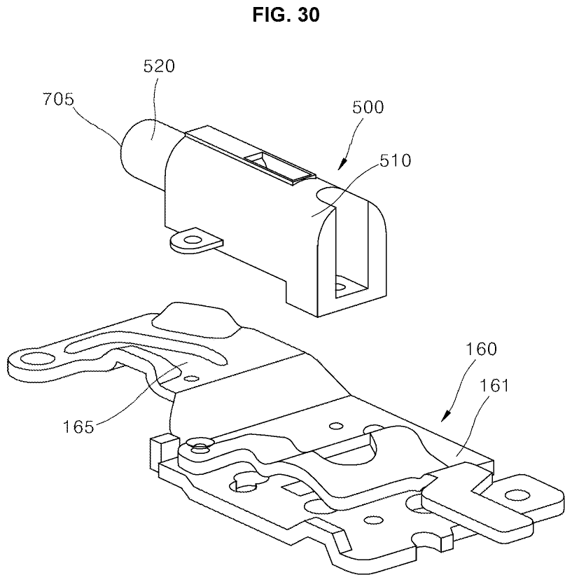

FIG. 26 is a planar cross-sectional view of the inner structures of a damper assembly and a hinge assembly of one embodiment, FIG. 27 is a plan view separately showing the damper assembly and the hinge assembly illustrated in FIG. 26, and FIG. 28 is a perspective view separately showing the damper assembly and the hinge assembly illustrated in FIG. 26. FIG. 29 is an exploded perspective view of exploded states of the damper assembly and the hinge assembly illustrated in FIG. 28, and FIG. 30 is an exploded perspective view of the damper assembly illustrated in FIG. 28 separating from the hinge assembly illustrated in FIG. 28.

Referring to FIGS. 26 to 30, the damper assembly 500 of the first embodiment may be installed at any one of the door 200 and the hinge assembly 150. The damper assembly 500 may generate a damping force while contacting the other of the door 200 and the hinge assembly 150.

In this embodiment, the damper assembly 500 generates a damping force while the damper assembly 500 is installed at the hinge assembly 150 and contacts the door 200, for example. Hereinafter, the operation and effect of the refrigerator are described in the case where the damper assembly 500 is installed at the hinge assembly 150, for example.

The hinge assembly 150, as described above, may be provided to connect the door 200 to the cabinet 100 rotatably. One side of the hinge assembly 150, i.e., a rear side of the hinge assembly 150, may be fixed to the cabinet 100.

Further, the other side of the hinge assembly 150, i.e., the front side of the hinge assembly 150, may connect to the door 200. At least a portion of the hinge assembly 150 may be inserted into the hinge mounting space 260.

As an example, the hinge assembly 150 may comprise a hinge 160, a hinge shaft 155, and the hinge case 170. The hinge 160 may be fixed to the door 200, and the hinge shaft 155 may be supported by the hinge 160. The hinge shaft 155 may be mounted on the hinge mounting part 261 and provide a rotation axis for rotation of the door 200.

The hinge case 170 may be coupled to the hinge 160 while surrounding a portion of the hinge 160 from the outside. The hinge case 170 may form the exterior of the hinge assembly 150 and accommodate the damper assembly 500.

The hinge case 170 may cover the hinge 160 from the outside such that the hinge 160 is not exposed to the outside. The rear side of the hinge case 170 may be coupled to the front surface of the cabinet 100, and the lower end of the hinge case 170 may be coupled to the hinge.

Most of the area of the hinge case 170 may be accommodated in the hinge mounting space 260. The hinge case 170 is coupled only to the hinge 160, and is not directly coupled to the door 200 such that the hinge case 170 is immune to the rotation of the door 200.

The hinge 160 may be coupled to the lower surface of the hinge mounting space 260 and disposed at a lower position than the damper assembly 500 spaced upward from the lower surface of the hinge mounting space 260 by a predetermined distance.

As an example, the hinge 160 may comprise a first hinge main body 161, and a second hinge main body 165.

The first hinge main body 161 may be disposed at the upper side of the cabinet 100. For example, the first hinge main body 161 may be disposed in an area where the first hinge main body 161 overlaps the cabinet 100 in the up-down direction. The first hinge main body 161 may be coupled to the upper surface of the cabinet 100.

The second hinge main body 165 may connect to the first hinge main body 161 in the front-rear direction, and be provided to protrude to the front of the cabinet 100. The second hinge main body 165 may connect to the door 200, at the front side of the cabinet 100.

The second hinge main body 165 may connect to the door 200, in the hinge mounting space 260. That is, at least a portion of the second hinge main body 165 may be inserted into the hinge mounting space 260 and rotatably connect to the door 200, in the hinge mounting space 260.

The hinge shaft 155 may be installed at the second hinge main body 165. The hinge shaft 155 may be provided to protrude from the second hinge main body 165 in the up-down direction. The hinge shaft 155 may be mounted on the hinge mounting part 261 (see FIG. 5) and provide a rotation axis for rotation of the door 200.

In this embodiment, the hinge 160 may be coupled to the cabinet 100 through the first hinge main body 161 and supported by the cabinet 100, and may be coupled to the door 200 through the hinge shaft 155 provided at the second hinge main body 165 and rotatably support the door 200.

The hinge 160 may have a sufficient strength to support the door 200. For example, the hinge 160 may be made of a metallic material having a greater strength than the hinge case 170.

The hinge case 170 may be disposed at the upper sides of the cabinet 100 and the hinge 160, and form the exterior of the hinge assembly 150. The hinge case 170 may be coupled to the upper surface of the hinge 160 or the cabinet 100, while accommodating at least a portion of the hinge 160. In this embodiment, the hinge case 170 accommodates the second hinge main body 165 and the damper assembly 500, for example.

The hinge case 170 may be shaped into a box which has an accommodation space therein, and the lower portion of which is open. The hinge case 170 may comprises an upper surface part 171, a front surface part 172 and a lateral surface part 173.

The upper surface part 171 may be disposed at the upper side of the hinge 160. As an example, the upper surface part 171 may be disposed at the upper side of the second hinge main body 165, and form a planar surface parallel with the upper surface of the cabinet 100. The upper surface part 171 may form the upper surface of the hinge case 170 covering the second hinge main body 165 from above.

The front surface part 172 and the lateral surface part 173 respectively may form a surface connecting between the hinge 160 and the upper surface part 171. As an example, the front surface part 172 and the lateral surface part 173 respectively may connect between the outer edge of the hinge 160 and the outer edge of the upper surface part 171.

The front surface part 172 may be disposed at the front side of the hinge 160, and the lateral surface part 173 may be disposed in the lateral portion of the hinge 160. The front surface part 172 may connect between the hinge 160 and the upper surface part 171 while blocking between the damper assembly 500 and a contact projection 270 described hereinafter. Additionally, the lateral surface part 173 may extend rearward from the end portions of both sides of the front surface part 172.

The rear surface of the hinge case 170 may be open, and accordingly, the inner space of the hinge case 170 may be open rearward. Most of the area of the damper assembly 500 may be accommodated in the hinge case 170, and a portion of the damper assembly 500 may protrude to the rear of the hinge case 170 through the open rear surface of the hinge case 170.

Like the hinge 160, the hinge case 170 may connect to the door 200, in the hinge mounting space 260. That is, at least a portion of the hinge case 170 may be inserted into the hinge mounting space 260. As the door 200 closes the storage compartment, the second hinge main body 165 and the hinge case 170 may be inserted into the hinge mounting space 260.

The refrigerator of this embodiment may further comprise a door cover 250. The door cover 250 may be installed at the door 200 while covering a portion of the rear surface of the door 200. At least a portion of the door cover 250 may be inserted into the hinge mounting space 260.

In this embodiment, the hinge mounting space 260 may form a space that is depressed forward from the rear surface of the door 200, in the door 200. The hinge mounting space 260 may be spaced downward from the upper end of the door 200 by a predetermined distance.

Additionally, the door 200 may have a cut part. The cut part may be disposed between the upper end of the door 200 and the hinge mounting space 260, while being formed on the rear surface of the door 200. The cut part may be formed in such a way that the rear surface of the door 200 is cut between the upper end of the door 200 and the hinge mounting space 260.

In this embodiment, the door cover 250 comprises a rear surface cover part 251, an upper surface cover part 252 and a front surface cover part 253, for example.

The rear surface cover part 251 may be disposed at the upper side of the door cover 250. The rear surface cover part 251 may connect to the upper surface cover part 252 while covering the cut part. The rear surface cover part 251 may cover the cut part while forming the same surface as the rear surface of the door 200.

The upper surface cover part 252 may be disposed between the rear surface cover part 251 and the front surface cover part 253 and connect between the rear surface cover part 251 and the front surface cover part 253. The upper surface cover part 252 may be inserted into the hinge mounting space 260, and cover the upper surface of the inside of the door 200, in the hinge mounting space 260.

The front surface cover part 253 may be disposed at the lower side of the door cover 250, and inserted into the hinge mounting space 260. The front surface cover part 253 may connect to the upper surface cover part 252 while covering the front surface of the door 200, in the hinge mounting space 260.

The cut part may provide a passage connecting between the upper end of the door 200 and the hinge mounting space 260, i.e., an up-down passage needed to approach from the upper side of the door 200 to the inside of the hinge mounting space 260.

The cut part may provide a passage ensuring an easy approach to the hinge assembly 150 and the hinge shaft 155 that are inserted into the hinge mounting space 260, and help to manage and repair the hinge assembly 150 and the damper assembly 500 readily.

The door cover 250 may cover the cut part, such that the cut part is not usually exposed. That is, the cut part is usually covered by the door cover 250 and not exposed to the outside, and in the case where the hinge assembly 150 or the damper assembly 500 needs to be managed and repaired, the door cover 250 separates from the door 200 to expose the cut part to the outside.

Further, the refrigerator in this embodiment may further comprise a contact projection 270. The contact projection 270 may be provided at the door 200, in such a way that the contact projection 270 protrudes toward the damper assembly 500. The contact projection 270 may be disposed in the hinge mounting space 260.

The damper assembly 500 may generate a damping force by contacting the contact projection 270, in the hinge mounting space 260, as the door 200 rotates in the closing direction.

The hinge case 170 may have an exit hole 174. The exit hole 174 may be formed in such a way that the exit hole 174 penetrates the front surface part 172 in the front-rear direction. The exit hole 174 may form a passage allowing the contact projection 270 to pass through the front surface part 172 and to move toward the damper assembly 500, at the front surface part 172.

In this embodiment, the contact projection 270 is installed at the door cover 250, for example. Accordingly, the contact projection 270 may be installed at the front surface cover part 253 and provided in such a way that the contact projection 27 protrudes rearward from the front surface cover part 253.

As an example, the door cover 250 may further comprise a projection coupling boss 255. The projection coupling boss 255 may protrude rearward from the front surface cover part 253. The projection coupling boss 255 may have a space therein, such that the contact projection 270 may be inserted into the projection coupling boss 255, and the rear end of the projection coupling boss 255 may be open.

The contact projection 270 may be coupled to the projection coupling boss 255 in such a way that a portion of the contact projection 270 is fitted into the projection coupling boss 255. The contact projection 270 coupled to the projection coupling boss 255 may be disposed in the hinge mounting space 260, and installed at the door cover 250 in such a way that the contact projection 270 protrudes rearward from the projection coupling boss 255.

The contact projection 270 may have a contact surface, at the rear end thereof. As an example, the contact surface may be a surface at the rear side of the contact projection 270. The contact surface may contact the damper assembly 500 as the damper assembly 500 contacts the contact projection 270.

In this embodiment, the contact surface of the contact projection 270 is formed in a rounded manner, for example. Detailed description in relation to this is provided hereinafter.

### [Mounting Structure of Damper Assembly]

In this embodiment, the damper assembly 500 may be installed at the hinge assembly 150, specifically, at the hinge 160, and contact the door 200 rotating in the closing direction and generate a damping force.

As an example, the cabinet 100 may be coupled to the hinge 160 and support the hinge 160, and the hinge 160 may be coupled to the damper assembly 500 and support the damper assembly 500. Specifically, the cabinet 100 may be coupled to the first hinge main body 161 and support the hinge 160, and the damper assembly 500 may be coupled to the second hinge main body 165 and supported by the hinge 160.

The damper assembly 500 installed at the hinge 160 may be fixed to the cabinet 100 through the hinge 160. The damper assembly 500 may be inserted into the hinge mounting space 260, as the door 200 rotates in the closing direction, and generate a damping force by contacting the above-described contact projection 270, in the hinge mounting space 260.

In this embodiment, the damper assembly 500 may be divided into a fixation part 510 and a movement part 520. The fixation part 510 may comprises a portion of the damper assembly 500, which is fixed to the hinge 160 and is not moved. For example, the fixation part 510 may comprise a damper case 800.

Additionally, the movement part 520 may comprise a portion of the damper assembly 500, which is movable based on a movement of the piston. For example, the movement part 520 may comprise a damper cover 700.

The damper assembly 500 may be provided with a contact end 705. The contact end 705 may be provided at the end portion of one side of the movement part 520 facing the hinge assembly 150, in the lateral direction of the movement part 520, while being provided to the movement part 520.

As an example, the lateral end of the movement part 520, contacting the contact projection 270, may be provided as the contact end 705, as the movement part 520 is pressed by the contact projection 270. As the damper assembly 500 contacts the contact projection 270, the contact end 705 may contact the contact surface of the contact projection 270.

While the damper assembly 150 operates, the movement part 520 moves in the front-rear direction, and accordingly, the position of the contact end 705 may change in the front-rear direction. For example, based on a rotation of the door 200 in the closing direction, the movement part 520 may move rearward, while the damper assembly 500 operates. Additionally, the position of the contact end 705 may change in a direction where the contact end becomes close to the fixation part 510, i.e., in the rearward direction.

That is, the movement part 520 may be inserted into the fixation part 510 while the position of the contact end 705 moves in the direction where the contact end becomes close to the fixation part 510, while the damper assembly 500 operates. As the movement part 520 moves in the opposite direction, the movement part 520 may protrude from the fixation part 510, while the movement part moves in a direction where the contact end 705 becomes far away from the fixation part 510.

The fixation part 510 may be coupled to the hinge 160, specifically, the second hinge main body 165. In this embodiment, the second hinge main body 165 may be provided in such a way that the second hinge main body protrudes to the front of the cabinet 100, and the fixation part 510 may be coupled to the second hinge main body 165 and disposed at a position protruding to the front of the cabinet 100.

The fixation part 510 may be disposed further rearward than the movement part 520, and the damper assembly 500 comprising the fixation part 510 may be disposed at a position protruding to the front of the cabinet 100, in the state of being fixed to the second hinge main body 165.

At least a portion of the damper assembly 500 disposed as described above may be accommodated in a space surrounded by the hinge 160 and the hinge assembly 170. The hinge case 170 may be disposed at the upper side of the second hinge main body 165, and most of the area of the damper assembly 500 may be accommodated in a space surrounded by the hinge case 170 and the second hinge main body 165.

A portion of the damper assembly 500 may protrude to the rear of the hinge case 170 through the open rear surface of the hinge case 170. The portion of the damper assembly 500, protruding to the rear of the hinge case 170, may be disposed at the upper areas of the cabinet 100 and the first hinge main body 161 coupled to the cabinet 100.

Accordingly, most of the area of the damper assembly 500 may be covered by the hinge case 170 and not seen from the outside, and the portion of the damper assembly 500, protruding to the rear of the hinge case 170, may also be covered by a cover covering the upper side of the cabinet 100, and not seen from the outside.

That is, the damper assembly 500 in this embodiment is provided in such a way that the damper assembly 500 operates in the state of being hidden at a position that is hardly seen, thereby effectively ensuring improvement in the quality feeling and quality exterior of the refrigerator.

### [Operations and Effects of Hinge Assembly and Damper Assembly]

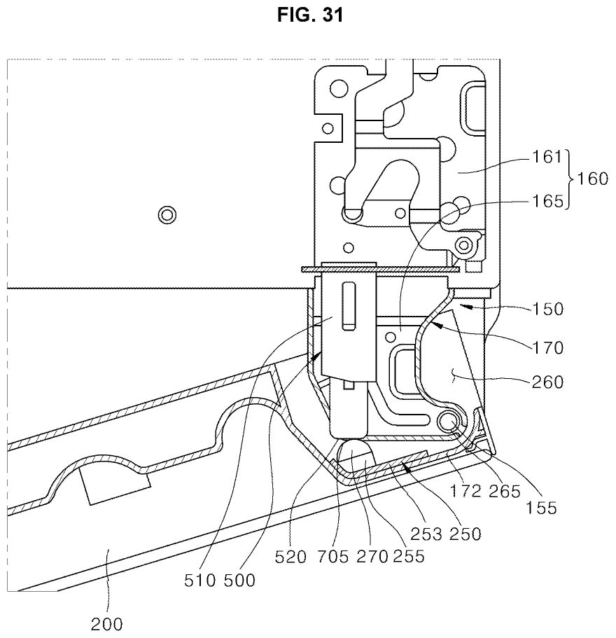

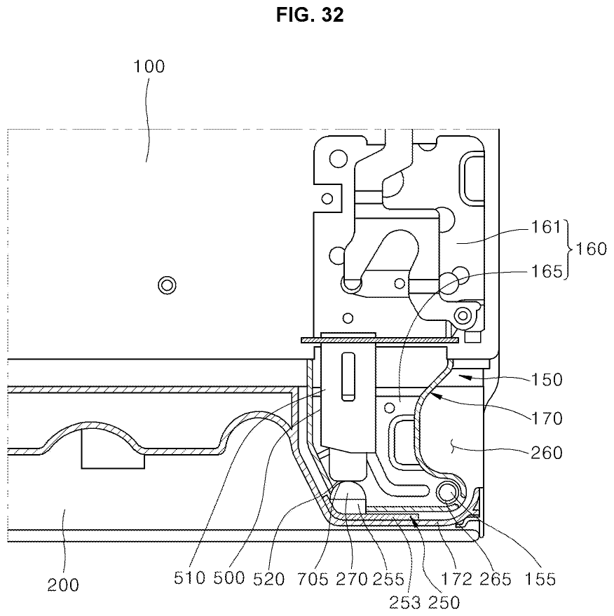

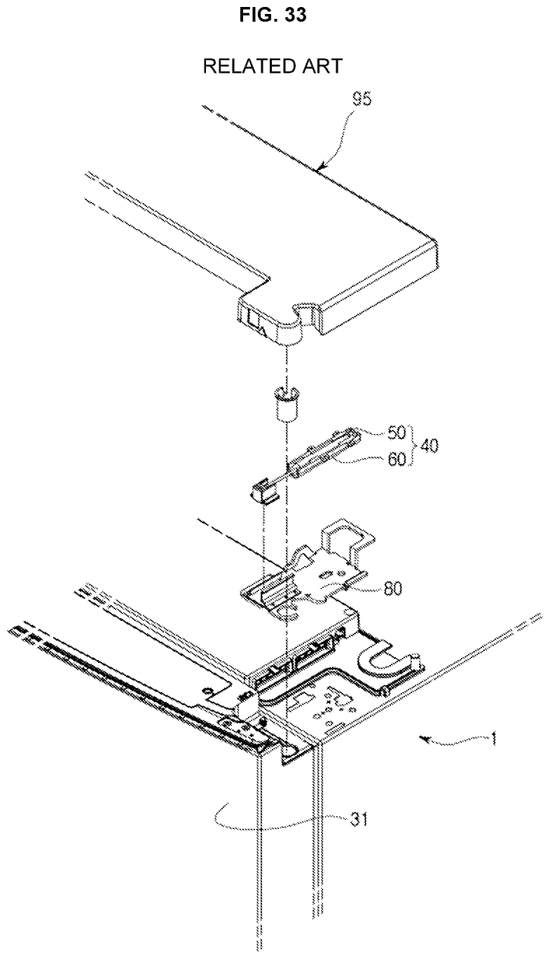

FIG. 31 is a planar cross-sectional view of mounted states of the damper assembly and the hinge assembly of one embodiment, and FIG. 32 is a planar cross-sectional view of an operating state of the damper assembly illustrated in FIG. 31.

Hereinafter, the operations and effects of the hinge assembly and the damper assembly in this embodiment are specifically described with reference to FIGS. 31 to 32.

As described above, the damper assembly 500 in this embodiment may be installed at the hinge 160, and generate a damping force while contacting the door 200 rotating in the closing direction.

In this embodiment, the cabinet 100 may be coupled to the hinge 160 to support the hinge 160, and the hinge 160 may be coupled to the damper assembly 500 to support the damper assembly 500.

The hinge case 170 may be made of a plastic material that is cheaper than a material of the hinge 160, to manufacture the hinge 160 without incurring large costs. However, the hinge 160 may be made of a metallic material having much greater strength than a material of the hinge case 170.

The hinge 160 may support the door 200 reliably such that the door 200 does not sag. Since the damper assembly 500 weights much less than the door 200, it is natural that the hinge 160 may also support the damper assembly 500 reliably, as long as the hinge 160 can support the door 200 reliably.

If the damper assembly 500 is installed at the hinge case 170 rather than the hinge 160, it is difficult for the hinge case 170 made of a plastic material of low strength to support the damper assembly 500 reliably.

In particular, as the damper assembly 500 is pressed by the door 200 or the contact projection 270 installed at the door 200, the hinge case 170 is highly likely to be damaged or the damper assembly 500 is highly likely to be taken off from the hinge case 170, in the case where the damper assembly 400 sags or severely sags.

Considering this, in this embodiment, the damper assembly 500 is installed at the hinge 160. In this embodiment, the hinge 160 may be made of a metallic material having greater strength than a material of the hinge case 170, such that the hinge 160 may be strong enough to support the door 200 reliably.

The hinge 160 may support the door 200 reliably, not to allow the door 200 to sag. Since the damper assembly 500 weighs much less than the door 200, it is natural that the hinge 160 may also support the damper assembly 500 reliably, as long as the hinge 160 can support the door 200 reliably.

Additionally, since the hinge 160 has strength that is high enough to support a force applied to the damper assembly 500 by the door 200 rotating in the closing direction, the hinge 160 may support the damper assembly 500 very reliably as well as the door 200.

That is, the damper assembly 500 is installed at the hinge 160 rather than the hinge case 170, such that the damper assembly 500 may be effectively prevented from sagging and being damaged.

In this embodiment, as the fixation part 510 is coupled to the second hinge main body 165, the damper assembly 500 may be fixed to the hinge 160, and the movement part 520 may be installed at the fixation part 510 in such a way that the movement part 520 is moveable in the front-rear direction.

As the door 200 rotates in the closing direction, the movement part 520 may move rearward while contacting the door 200. As the movement of the movement part 520 occurs, the damper assembly 500 may reduce a rotation speed of the door 200 while generating a damping force. The movement part 520 may contact the door 200 through the contact projection 270 installed at the door 200.

In this embodiment, most of the area of the damper assembly 500 comprising the movement part 520 is accommodated in the hinge case 170, and the front surface part 172 of the hinge case 170 may block between the movement part 520 and the contact projection 270.

The exit hole 174 may be formed in such a way that the exit hole 174 penetrates the front surface part 172 of the hinge case 170 in the front-rear direction, and the contact projection 270 may enter into the hinge case 170 by passing through the front surface part 172 of the hinge case 170 through the exit hole 174.

As the door 200 rotates in the closing direction, the contact projection 270 may enter into the hinge case 170 while moving rearward together with the door 200. The contact projection 270 having entered into the hinge case 170 may contact the movement part 520, in the hinge case 170.

The contact projection 270 may comprise a contact surface that is rounded. The contact surface of the contact projection 270, as a surface that contacts the contact end 705 of the movement part 520 as the contact projection 270 contacts the damper assembly 500, may be a surface at the rear side of the contact projection 270.

As an example, the contact projection 270 may be formed in such a way that the contact projection 270 is convex toward the damper assembly 500, in a shape that is rounded in the up-down direction and the lateral direction. In this embodiment, the contact projection 270 is formed in such a way that the contact projection 270 protrudes toward the damper assembly 500 in a hemisphere shape, for example.

For example, the contact projection 270 may be provided in such a way that an anterior portion fitted into the projection coupling boss 255 and a posterior portion protruding to the rear of the projection coupling boss 255 are integrally formed. The anterior portion and the posterior portion may connect in the front-rear direction, and the anterior portion may be shaped into a cylinder, to be fitted into the projection coupling boss 255. The posterior portion protruding to the rear of the projection coupling boss 255 may be shaped into a hemisphere that forms a curved surface in the lateral direction and the up-down direction.

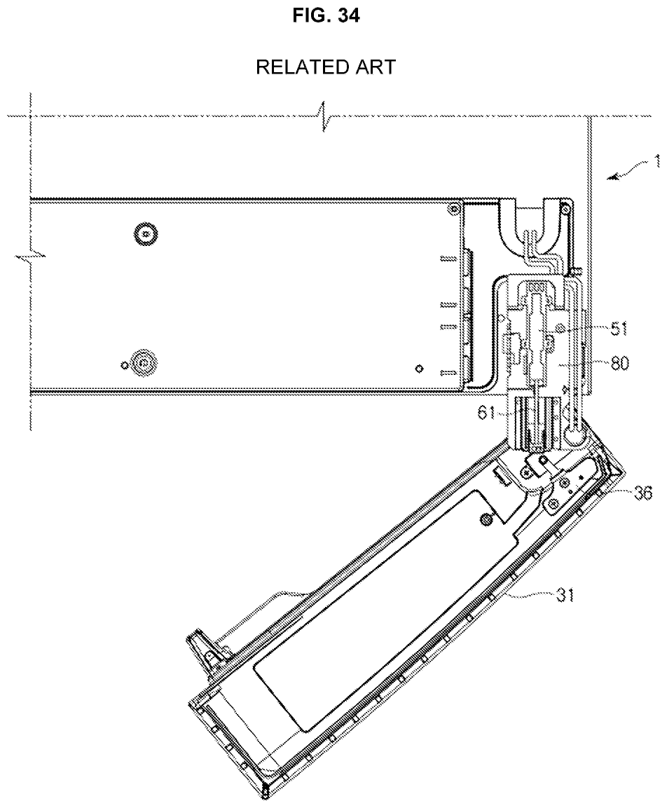

The contact projection 270 may be provided as one member that is integrally formed as a whole, to have greater rigidity than a press roller part 36 (see FIG. 34) in prior art document 1, which is provided in such a way that various components are combined.

Additionally, the contact projection 270 may have a shape comprising a rotator shape such as a sphere or a hemisphere and the like ensuring high structural reliability and have greater structural reliability and strength than the press roller part 36 of prior art document 1.

The contact projection 270 in this embodiment has excellent structural reliability and strength, ensuring excellent structural reliability and strength, such that the contact projection 270 may not be readily worn away or damaged despite repetitive contact with the damper assembly 500.

Further, since the contact projection 270 is fitted and coupled to the projection coupling boss 255, the contact projection 270 may be installed at the door cover 250 and the door 200 in a separable manner. The contact projection 270 may be readily separated from the door cover 250 and the door 200 and replaced in the case where the contact projection 270 is worn away or damaged, thereby enabling efficient management and repairs of the refrigerator.

Since the contact surface of the contact projection 270 formed as described above forms a curved surface in the lateral direction and the up-down direction, the contact surface of the contact projection 270 may form a curved surface in the direction (up-down direction) where the door 200 moves at a time when the door 200 sags as well as forming a curbed surface in the direction (lateral direction) where the door 200 rotates.

In this embodiment, the contact projection 270 having the contact surface formed as described above may help with smooth contact between the contact surface of the contact projection 270 and the contact end 705 of the movement part 520, as the contact projection 270 contacts the movement part 520 of the damper assembly 500.

In the case where the door 200 continues to rotate in the closing direction, in the state where the contact projection 270 contacts the movement part 520, the movement part 520 is pressed by the contact projection 270 moving rearward together with the door 200 and moves rearward.

At this time, since the contact projection 270 moves integrally together with the door 200 rotating in the closing direction, the position of the contact projection 270 may change in the lateral direction as well as the rearward direction. As the movement part 520 moves while being pressed by the contact projection 270, the contact projection 270 may slide along the contact end 705 of the movement part 520 in the lateral direction. On the contrary, the movement part 520 moves rearward while sliding along the contact surface of the contact projection 270 in the lateral direction.

In this embodiment, since the contact surface of the contact projection 270 forms a curved surface in the direction (lateral direction) where the door 200 rotates, a lateral slide of the contact projection 270 relative to the contact end 705 of the movement part 520 or a lateral slide of the movement part 520 relative to the contact surface of the contact projection 270 may be performed very smoothly.

Additionally, since the contact surface of the contact projection 270 also forms a curved surface in the direction (up-down direction) where the door 200 moves, in the case where the door 200 sags, an up-down slide of the contact projection 270 relative to the contact end 705 of the movement part 520 or an up-down slide of the movement part 520 relative to the contact surface of the contact projection 270 may be performed very smoothly despite a sag of the door 200.

In prior art document 1, the press roller part 36 comprises a roller rotating around an axis in the up-down direction. As the press roller part 36 presses a press rod 61 (see FIG. 34), the press roller part 36 may press the press rod 61 while sliding relative to the press rod 61 in the lateral direction through the roller, thereby reducing an impact applied to the press rod 61.

However, the roller of the press roller part 36 only rotates around an axis in the up-down direction but does not rotate around an axis in the lateral direction or the front-rear direction. Accordingly, the press roller part 36 in prior art document 1 reduces an impact applied to the press rod 61, which is based on a rotation of the door, but hardly responds properly to a force applied to the press roller part 36 or the press rod 61, which is based on a sag of the door.

In this embodiment, the contact surface of the contact projection 270 may also form a curved surface in the direction where the door 200 moves, in the case where the door 200 sags. Thus, at a time of sagging of the door 200, an up-down slide of the contact projection 270 relative to the contact end 705 of the movement part 520 or an up-down slide or a front-rear slide of the movement part 520 relative to the contact surface of the contact projection 270, as well as a lateral slide of the contact projection 270 or the movement part 520, may be performed very smoothly. Thus, even in the case where a force is applied to the contact projection 270 or the damper assembly 500 in the up-down direction or the front-rear direction due to sagging of the door, an effect of the force may be offset by an up-down slide or a front-rear slide of the contact projection 270 or the movement part 520.

That is, the contact projection 270 and the damper assembly 500 contacting the contact projection 270, in this embodiment, may respond to a force that is applied to the contact projection 270 or the damper assembly 500 because of sagging of the door very effectively.

As described above, a combination of the contact projection 270 and the damper assembly 500 in this embodiment is provided to effectively respond to the sagging of the door, such that the operation of the damper assembly 500 is performed smoothly as set, regardless of the sagging of the door.

Further, the contact projection 270, formed in a rounded manner as described above, may have a shape in which a length in the up-down direction and a length in the lateral direction increase further in the rearward direction. That is, the hemisphere-shaped contact projection 270 may have a shape in which a length is the least at the rear end of the shape and increases gradually toward the front of the shape.

As described above, the contact projection 270 passes through the front surface part 172 of the hinge case 170 through the exit hole 174, and the rear end of the contact projection 270, having the least length, passes through the exit hole 174 earlier than any other portion of the contact projection 270, such that the contact projection 270 passes through the exit hole 174 very easily.

Additionally, since the contact projection 270 is formed in a rounded manner in a hemisphere shape, the contact projection 270 may pass through the exit hole 174 smoothly, sliding relative to the inner circumferential surface of the front surface part 172, without being held by the front surface part 172 of the hinge case 170, even in the case where the contact projection 270 contacts the hinge case 170 while the contact projection 270 passes through the exit hole 174.

The refrigerator in this embodiment may offset an effect caused due to the sagging of the door, based on a slide of the damper assembly 500 along the curved surface of the contact projection 270 as described above, such that the operation of the damper assembly 500 is performed smoothly as set, regardless of the sagging of the door.

The refrigerator in this embodiment may provide a damping function smoothly, regardless of the sagging of the door.

The refrigerator in this embodiment may allow the damper assembly 500 to operate in the state where the damper assembly 500 remains hidden at a position that is hardly seen, ensuring improvement in the quality feeling and quality exterior of the refrigerator.

The refrigerator in this embodiment may be provided with the contact projection 270 formed to have a shape comprising a curved surface that helps to pass through the exit hole 174, and even in the case where the damper assembly 500 is hidden in the hinge case 170 and hardly seen, contact between the damper assembly 500 and the contact projection 270 and a damping function based on the contact may be performed smoothly.

The embodiments are described above with reference to a number of illustrative embodiments thereof. However, the embodiments are provided as examples, and numerous other modifications and embodiments can be drawn by one having ordinary skill in the art from the embodiments. Thus, the technical scope of protection of the subject matter of the invention is to be defined according to the following claims.

### DESCRIPTION OF REFERENCE NUMERALS

100: Cabinet
101: Pillar rotation member
150: Hinge assembly
155: Hinge shaft
160: Hinge
161: First hinge main body
165: Second hinge main body
170: Hinge case
171: Upper surface part
172: Front surface part
173: Lateral surface part
174: Exit hole
175: Coupling surface
200: Door
210: First door
220: Second door
230: Lower door
240: Dispenser
250: Door cover
251: Rear surface cover part
252: Upper surface cover part
253: Front surface cover part
255: Projection coupling boss
260: Hinge mounting space
261: Hinge mounting part
265: Damper assembly mounting part
270: Contact projection
500: Damper assembly
510: Fixation part
520: Movement part
600: Damper
610: Housing
611: Elastic member
612: Oil
620: Rod
621: Step part
630: Guide
640: Sealer
650: Sponge
651: Sponge cover
660: Washer
670: Piston
671: First piston part
672: Second piston part
673: Oil flow path part
673a: First flow path
673b: Second flow path
673c: Third flow path
674: Inlet
675: Outlet
680: Ring
681: Oil return passage
690: Bracket
691: Drawn part
700: Damper cover
701: Cover body
705: Contact end
710: Rail part
711: Reinforcement part
720: Holding part
721: Insertion part
740: First guide rib
800: Damper case
801: Case body
810: Guide part
820: Slit part
830: Second guide rib
840: Fastening part
841: Fastening hole
850: Case groove
900: Reinforcement plate
950: Drawn groove

What is claimed is:

1. A refrigerator comprising:
a cabinet having a storage compartment;
a door configured to open and close the storage compartment;
a hinge connected to the cabinet, the hinge rotatably connecting the door to the cabinet; and
a damper connected to the hinge to be supported by the hinge, the damper being configured to generate a damping force by contacting the door when the door moves towards a closed position,
wherein a majority of an overall length of the damper extends beyond a front surface of the cabinet.

2. The refrigerator of claim 1, further comprising a hinge case configured to accommodate at least a portion of the hinge, the hinge case being connected to the hinge,
wherein at least a portion of the damper is accommodated in a space defined by the hinge and the hinge case.

3. The refrigerator of claim 2, wherein the hinge comprises:
a first hinge main body overlapping the cabinet in an up-down direction, the first hinge main body being connected to the cabinet; and
a second hinge main body configured to protrude to a front of the cabinet, the second hinge main body being connected to the door, the second hinge main body and the hinge case defining the space, and
wherein the damper is connected to the second hinge main body.

4. The refrigerator of claim 3, wherein the door includes a hinge mounting space that is open towards the cabinet,
wherein the hinge is connected to the door in the hinge mounting space, and
wherein, as the door moves towards the closed position, the second hinge main body and the hinge case are inserted into the hinge mounting space.

5. The refrigerator of claim 1, wherein the door includes a contact projection configured to protrude toward the damper, and
wherein the damper is configured to generate the damping force by contacting the contact projection.

6. The refrigerator of claim 5, further comprising a hinge case configured to accommodate at least a portion of the hinge, the hinge case being connected to the hinge,
wherein the contact projection contacts the damper in a space defined by the hinge and the hinge case.

7. The refrigerator of claim 5, wherein the contact projection includes a rounded contact surface configured to contact the damper.

8. The refrigerator of claim 5, further comprising a hinge case configured to accommodate at least a portion of the hinge, the hinge case being connected to the hinge, the hinge case having a passage configured to allow the contact projection to pass through the hinge case towards the damper as the door moves towards the closed position.

9. The refrigerator of claim 8, wherein the hinge case includes:
an upper part covering the hinge from above with the damper located between the upper part and the hinge; and
a front part connecting the upper part to the hinge, the front part having the passage to allow the contact projection to pass through the front part as the door moves towards the closed position.

10. The refrigerator of claim 9, wherein the passage extends through the front part in a front-rear direction, and
wherein the contact projection has a shape in which a length in an up-down direction and in a left-right direction increases away from the cabinet.

11. The refrigerator of claim 5, wherein the damper includes:
a fixation part fixed to the door; and
a movement part movable relative to the fixation part, the movement part having a contact end having a planar shape at an end portion thereof, the movement part being configured to move in a front-rear direction while the contact end contacts the contact surface.

12. The refrigerator of claim 5, wherein the contact surface is convex towards the damper.

13. The refrigerator of claim 5, wherein the contact surface has a hemispherical shape.

14. The refrigerator of claim 5, wherein the door includes a hinge mounting space that is open towards the cabinet,
wherein the hinge is connected to the door in the hinge mounting space, and
wherein the contact projection is accommodated in the hinge mounting space.

15. The refrigerator of claim 14, further comprising a door cover at the door, at least a portion of the door cover being inserted into the hinge mounting space,
wherein the contact projection is located at the door cover.

16. The refrigerator of claim 15, wherein the hinge mounting space extends forward from a rear surface of the door,
wherein the door cover includes:
an upper cover part covering an upper surface of an inside of the door in the hinge mounting space; and
a front cover part connected to the upper cover part, the front cover part covering a front surface of the inside of the door in the hinge mounting space, and
wherein the contact projection is located at the front cover part to protrude rearward from the front cover part.

17. The refrigerator of claim 16, wherein the hinge mounting space is located downward from an upper end of the door,
wherein the door includes a cut part located between the upper end of the door and the hinge mounting space on the rear surface of the door, and
wherein the door cover further includes a rear cover part covering the cut part, the rear cover part being connected to the upper cover part.

18. The refrigerator of claim 16, wherein the door cover further includes a projection coupling boss protruding rearward from the front cover part, and
wherein the contact projection is connected to the projection coupling boss to protrude rearward from the projection coupling boss.

19. A refrigerator comprising:
a cabinet having a storage compartment;
a door configured to open and close the storage compartment;
a hinge configured to rotatably connect the door to the cabinet;
a damper supported by the hinge; and
a contact projection provided at the door to protrude toward the damper, the contact projection having a contact surface rounded in an up-down direction and in a lateral direction,
wherein the damper is configured to generate a damping force by contacting the contact surface as the door moves toward a closed position.

20. A refrigerator comprising:
a cabinet having a storage compartment;
a door configured to open and close the storage compartment;
a hinge coupled to the cabinet, the hinge rotatably connecting the door to the cabinet;
a damper connected to the hinge to be supported by the hinge;
a hinge case configured to accommodate at least a portion of the hinge, the hinge case being connected to the hinge; and
a contact projection provided at the door to protrude toward the damper, the contact projection having a contact surface rounded in an up-down direction and in a lateral direction,
wherein the damper is configured to generate a damping force by contacting the contact surface when the door moves towards a closed position.
